(19) United States
(12) Patent Application Publication
(10) Pub. No.: US 2015/0120467 A1
(43) Pub. Date: Apr. 30, 2015

(54) COOPERATIVE OFFERING METHODS AND SYSTEMS

(71) Applicants: Kevin Thomas Hermida, New York, NY (US); Jonathan William Opdyke, New York, NY (US); Vardaan Vasisht, New York, NY (US)

(72) Inventors: Kevin Thomas Hermida, New York, NY (US); Jonathan William Opdyke, New York, NY (US); Vardaan Vasisht, New York, NY (US)

(73) Assignee: HOOKLOGIC, INC., New York, NY (US)

(21) Appl. No.: 14/063,889

(22) Filed: Oct. 25, 2013

(51) Int. Cl. G06Q 30/02

(52) U.S. Cl. CPC G06Q 30/0275
USPC 705/14.71; 705/14.4

(57) ABSTRACT

This disclosure relates generally to advertising, and more particularly to cooperative offering methods and systems. In one embodiment, a cooperative offer generating system is disclosed, comprising: a processor; and a memory storing processor-executable instructions comprising instructions for: obtaining one or more parameters; identifying an item related to the one or more parameters; determining a plurality of offerors corresponding to the item; obtaining cooperative offer parameters for the offerors; generating a cooperative offer related to the item, including: determining a cooperative offer value, and determining a cooperative offer value share for at least one of the offerors; and providing the generated cooperative offer. In some embodiments, the cooperative offer is an online advertisement bid to advertise the item.

### TECHNICAL FIELD

This disclosure relates generally to advertising, and more particularly to cooperative offering methods and systems.

### BACKGROUND

Offers for various types of goods and services are delivered via the Internet. Examples of such offers include e-mail marketing, display advertisements (such as web banner advertisements), search advertisements, and in-app offers (e.g., within mobile applications). Other examples include websites such as retail merchandising, airline, car rental, online meal ordering, travel booking, hotel booking, etc., websites, which present offers for goods and services in response to user input. Another category of offers includes bids submitted in online auctions of goods and services of various types. A sub-category therein relates to bids submitted in real-time auctions of online advertising space. For example, a product retailer may submit a bid at an online auction to purchase advertising space on a webpage delivered to a user's computer, so that the retailer's product advertisement may be displayed on the webpage.

### SUMMARY

In one embodiment, a cooperative offer generating system is disclosed, comprising: a processor; and a memory storing processor-executable instructions comprising instructions for: obtaining one or more parameters; identifying an item related to the one or more parameters; determining a plurality of offerors corresponding to the item; obtaining cooperative offer parameters for the offerors; generating a cooperative offer related to the item, including: determining a cooperative offer value, and determining a cooperative offer value share for at least one of the offerors; and providing the generated cooperative offer.

In one embodiment, a cooperative offer generation method is disclosed, comprising: obtaining one or more parameters; identifying an item related to the one or more parameters; determining a plurality of offerors corresponding to the item; obtaining cooperative offer parameters for the offerors; generating, via a processor, a cooperative offer related to the item, including: determining a cooperative offer value, and determining a cooperative offer value share for at least one of the offerors; and providing the generated cooperative offer.

In one embodiment, a non-transitory computer-readable medium is disclosed, storing computer-executable cooperative offer generation instructions comprising instructions for: obtaining one or more parameters; identifying an item related to the one or more parameters; determining a plurality of offerors corresponding to the item; obtaining cooperative offer parameters for the offerors; generating a cooperative offer related to the item, including: determining a cooperative offer value, and determining a cooperative offer value share for at least one of the offerors; and providing the generated cooperative offer.

In one embodiment, a client apparatus is disclosed, comprising: a processor; a display unit disposed in communication with the processor; and a memory disposed in communication with the processor and storing processor-executable instructions, the instructions comprising instructions for: providing a request for display content; obtaining an advertisement selected for delivery to the client apparatus based on a cooperative offer submitted to a bidding server; rendering the advertisement for display; and displaying the advertisement via the display unit.

In one embodiment, a cooperative offer-based advertising method is disclosed, comprising: providing a request for display content; obtaining an advertisement selected for delivery to a client apparatus based on a cooperative offer submitted to a bidding server; rendering, via a processor, the advertisement for display; and displaying the advertisement via a display unit.

In one embodiment, a non-transitory computer-readable medium is disclosed, storing computer-executable cooperative offer-based advertising instructions comprising instructions for: providing a request for display content; obtaining an advertisement selected for delivery to a client apparatus based on a cooperative offer submitted to a bidding server; rendering the advertisement for display; and displaying the advertisement via a display unit.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIGS. 1A-E illustrate example digital media wherein cooperative offers may be displayed, and example aspects of cooperative offers, according to some embodiments.

FIGS. 2A-E illustrate example cooperative offering parameters, and example user interface screens for modifying cooperative offering parameters, according to some embodiments.

FIGS. 3A-C are flow diagrams illustrating example methodologies for generating cooperative offers, in accordance with some embodiments.

FIGS. 4A-B are flow diagrams illustrating an example procedure for generating cooperative offers, consistent with the methodology illustrated in FIG. 3A.

FIG. 5 is a block diagram of example components for a cooperative advertisement bidding system, according to some embodiments.

FIGS. 6A-E are flow diagrams illustrating an example procedure for real-time cooperative advertisement bidding, in accordance with some embodiments.

FIG. 7 is a block diagram of an example computer system for implementing embodiments consistent with the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

Embodiments of the present disclosure provide features whereby different parties may be aligned to create bidding efficiencies. As a purely illustrative, non-limiting example, a product retailer may submit a bid at an online real-time-bidding auction to purchase advertising space on a webpage delivered to a user's computer, so that a product advertisement may be displayed on the webpage. A manufacturer of the same product may also be interested in having the product advertisement be displayed on the webpage. Coincidentally, the manufacturer may be submitting a separate bid from the retailer to have the same product advertisement displayed on the webpage. Each of the bids of the retailer and the manufacturer, by themselves, may be too low to ultimately win the online auction in the face of competition from other bidders.

However, if the manufacturer and retailer's commonality of interest can be identified ahead of the time that a bid must be placed in the auction, the bid amounts of the retailer and manufacturer can be added together, creating a single bid with a much greater chance of ultimately winning the auction, and securing the advertising space on the webpage for the product advertisement that both the manufacturer and the retailer desire.

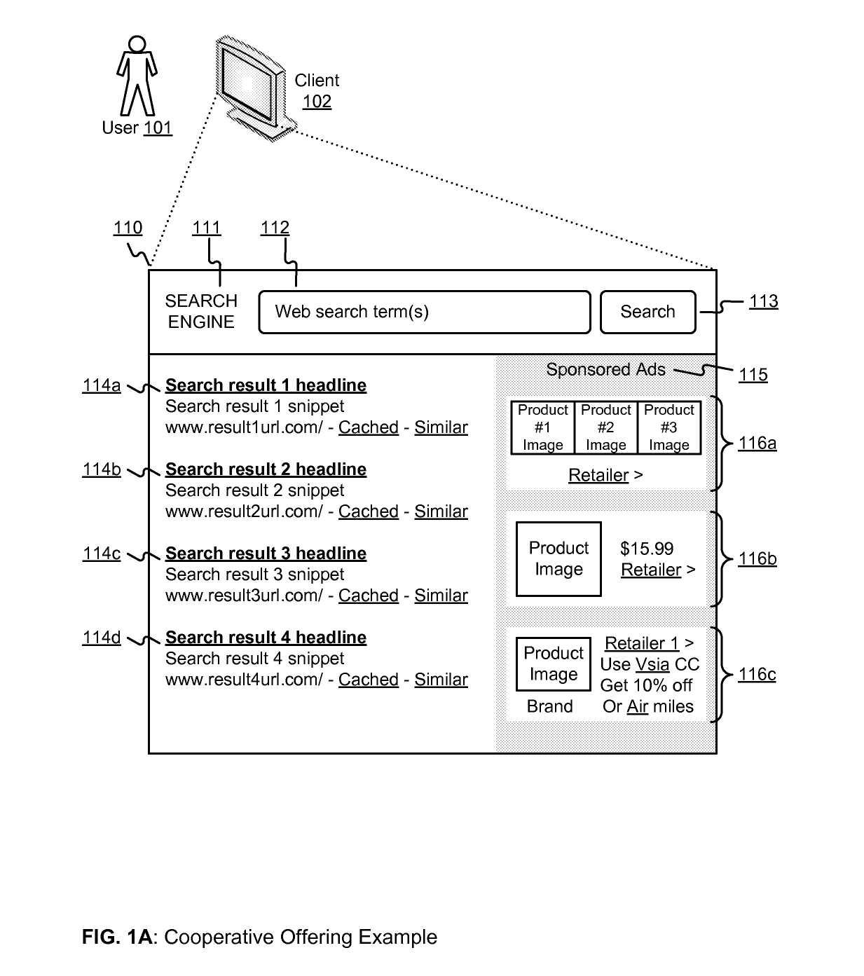

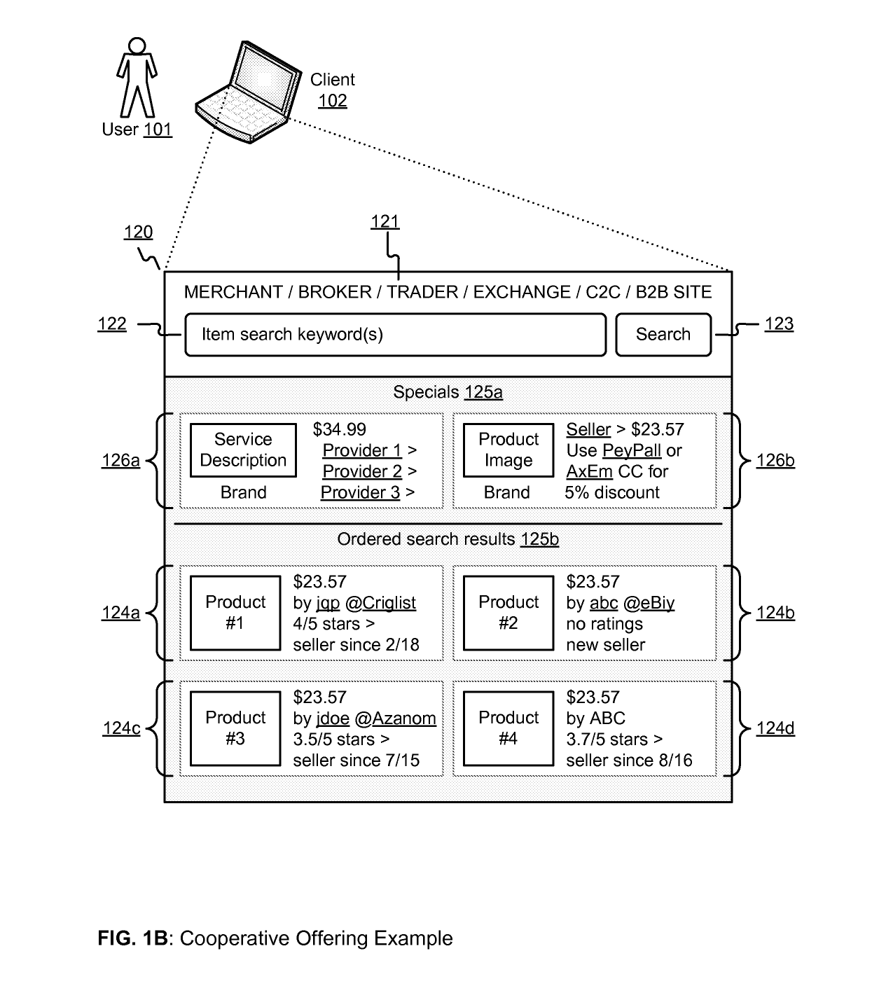

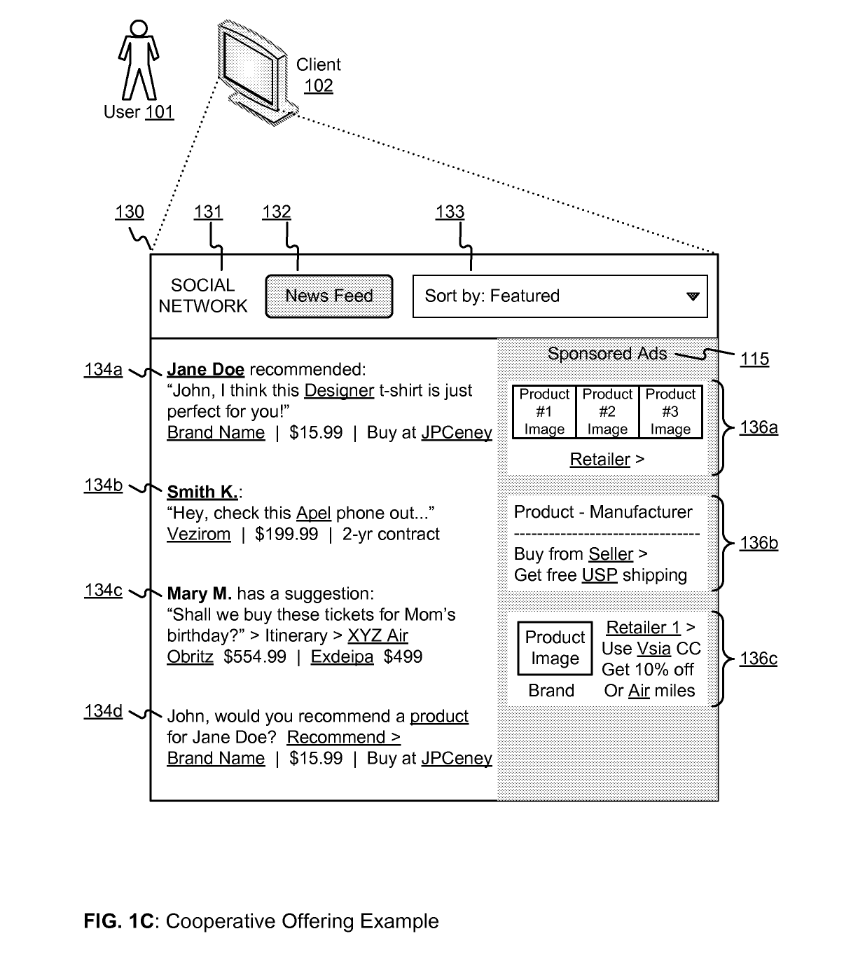

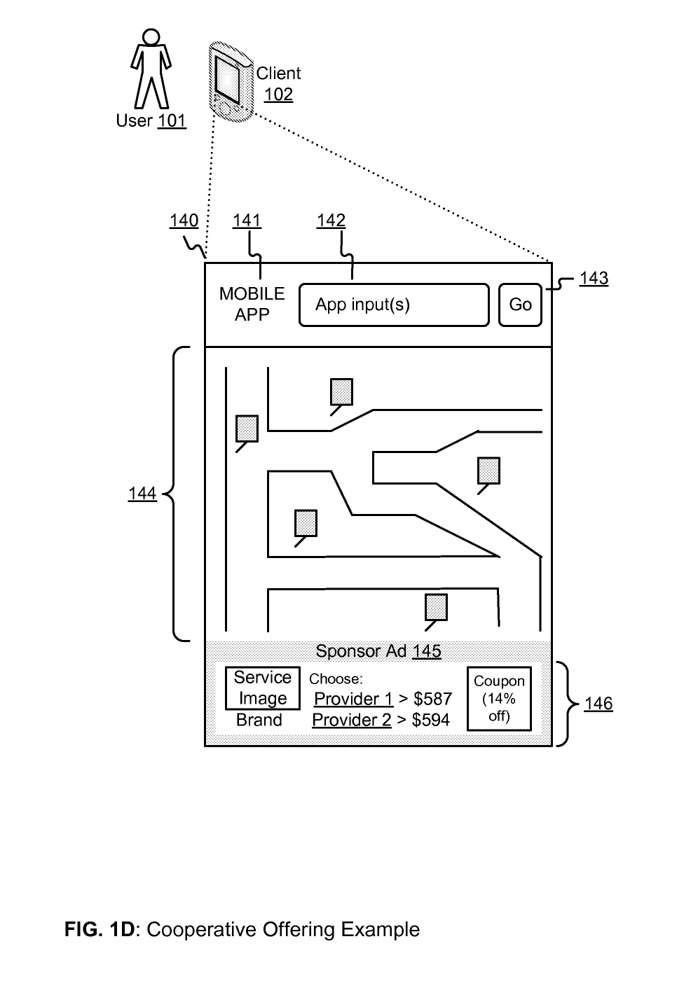

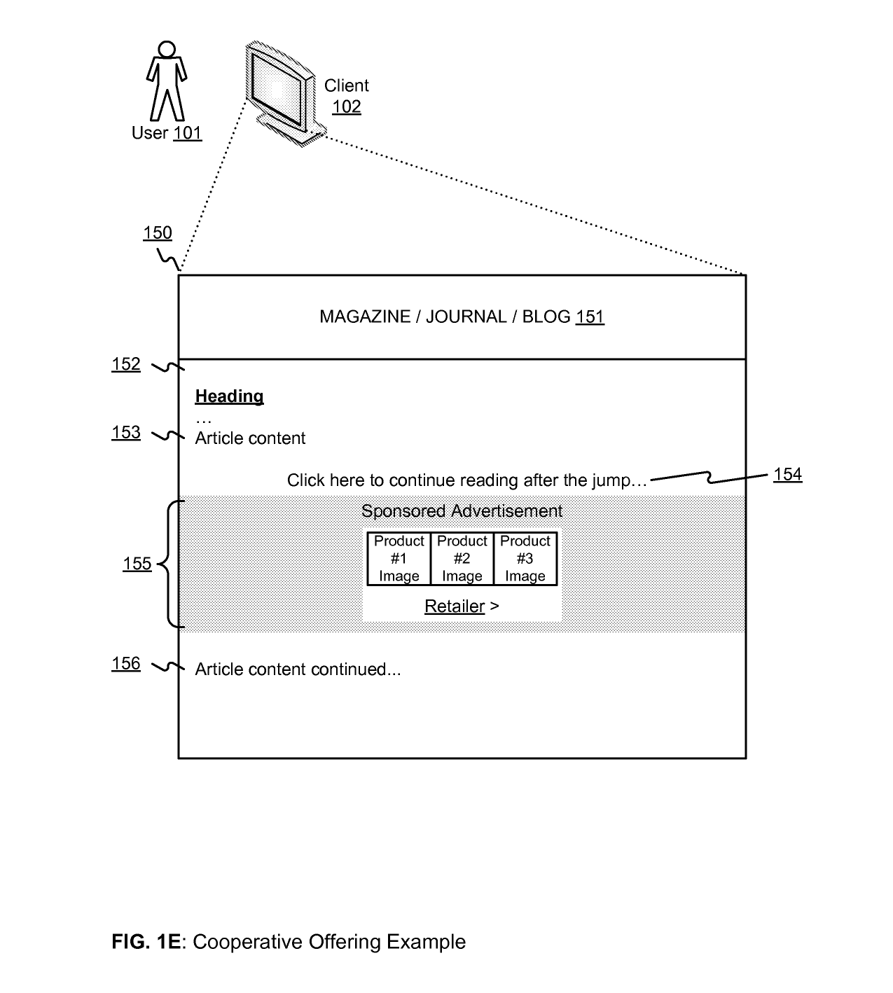

Although the example above is placed in the context of bidding at a real-time online auction for advertising space on a webpage by a retailer and a manufacturer, it is to be understood that the present disclosure can be applied to various other contexts; a few of these will be discussed with reference to FIGS. 1A-E. In general, the teachings of the present disclosure can be applied to any context wherein two or more different parties share a common interest that a particular outcome occur, and wherein their cooperative action can increase the probability of occurrence of that outcome.

FIGS. 1A-E illustrate example digital media wherein cooperative offers may be displayed, and example aspects of cooperative offers, according to some embodiments. Here, a digital medium may include, without limitation, a web search results page; a commercial website page; a social networking website page; a user interface of a mobile application; and an article web page; etc.

With reference to FIG. 1A, in some embodiments, a client 102 may display a search results page 110 for a user 101. The search results page may be provided by a search provider 111, such as Google, Yahoo!, Microsoft Bing, AskJeeves, etc. A user may provide web search term(s) into a graphical user interface (GUI) element 112, and initiate a web search by activating a GUI element 113. Web search results 114a-d may be provided via the user interface screen, and alongside the web search results, advertisements 115 may be provided that are relevant to the web search term(s). In some embodiments, the advertisements 115 may be the result of a cooperative offer being provided for the advertising space, and the cooperative offer being accepted. Although it is not necessary that the displayed advertisement reflect the cooperative nature of the offer resulting in the advertisement being displayed (e.g., the advertisements need not indicate the identities of all or even any of the parties that cooperated to generate the cooperative offer), several example advertisements are illustrated that indicate the identity of at least one of the offering parties. For example, advertisement 116a may provide an indication of multiple products being sold by a retailer. The offer that yields this advertisement may be cooperatively generated by the retailer, and one or more entities such as a manufacturer, a product designer, a supplier in a supply chain for the product, etc. As another example, advertisement 116b may provide an indication of a single product being sold by a retailer. The offer that yields this advertisement may also be cooperatively generated by the retailer, and one or more entities such as a manufacturer, a product designer, a supplier in a supply chain for the product, etc. As another example, advertisement 116c may provide an indication of a product being offered by a retailer for purchase using a particular payment mechanism (e.g., a credit card offered by a financial institution). The offer that yields this advertisement may be cooperatively generated by the retailer, a payment mechanism provider, one or more financial institutions that may benefit from the product offering being accepted by the user 101, etc.

With reference to FIG. 1B, in some embodiments, a client 102 may display a merchant site, a broker site, a trader site, an exchange site, a consumer-to-consumer site, a business-to-business site or other digital property, etc. A user may provide item search keyword(s) into a graphical user interface (GUI) element 122, and initiate a search by activating a GUI element 123. Search results 124a-d may be provided via the user interface screen, and alongside the search results, advertisements 126a-b may be provided that are relevant to the search term(s). In some embodiments, the advertisements 126a-b may be the result of a cooperative offer being provided for the advertising space, and the cooperative offer being accepted. For example, multiple providers may cooperate to generate an offer that yields the advertisement 126a. Similarly, a seller, a product manufacturer, and one or more payment mechanism providers may cooperate to generate an offer that yields the advertisement 126b. Moreover, the search results 124a-d themselves may be generated and/or ordered according to an auction for placement of the search results.

With reference to FIG. 1C, in some embodiments, a client 102 may display a social networking webpage 130 for a user 101. The social networking site 131 providing the webpage 130 may provide a data feed (see element 132), and a GUI element 133 to search for items in the data feed. The (search-filtered) data feed may include items 134a-d. Alongside the data feed, an advertisements panel 115 may include advertisements 136a-c that are relevant to the data feed or to the search term(s) used to search for items in the data feed.

With reference to FIG. 10, in some embodiments, a client 102 may be executing an application, which may provide a user interface screen 140 for user 101. For example, the application may be a mobile app 141. The user 101 may be able to provide input 143 into the mobile app, and activate a GUI element 143 to initiate processing of the user input by the mobile application. The mobile application may provide digital media content 144 for the user, alongside sponsored advertisements 145 within the mobile application. The selection of advertisement 146 to be displayed within the mobile application may be selected by an offering process, and multiple entities may cooperate to generate offers to place their advertisement in the mobile application context.

With reference to FIG. 1E, in some embodiments, a client 102 may display a page 150 of a magazine, journal, blog, etc., 151, for a user. The page may provide digital media content 153 within a frame 152. In some embodiments, an advertisement 155 may be placed within the framework of the context (see elements 154, 156). Such as advertisement's selection and/or placement may be determined by an offering process, wherein one or more different entities may cooperate to generate cooperative offers for the product selection and placement.

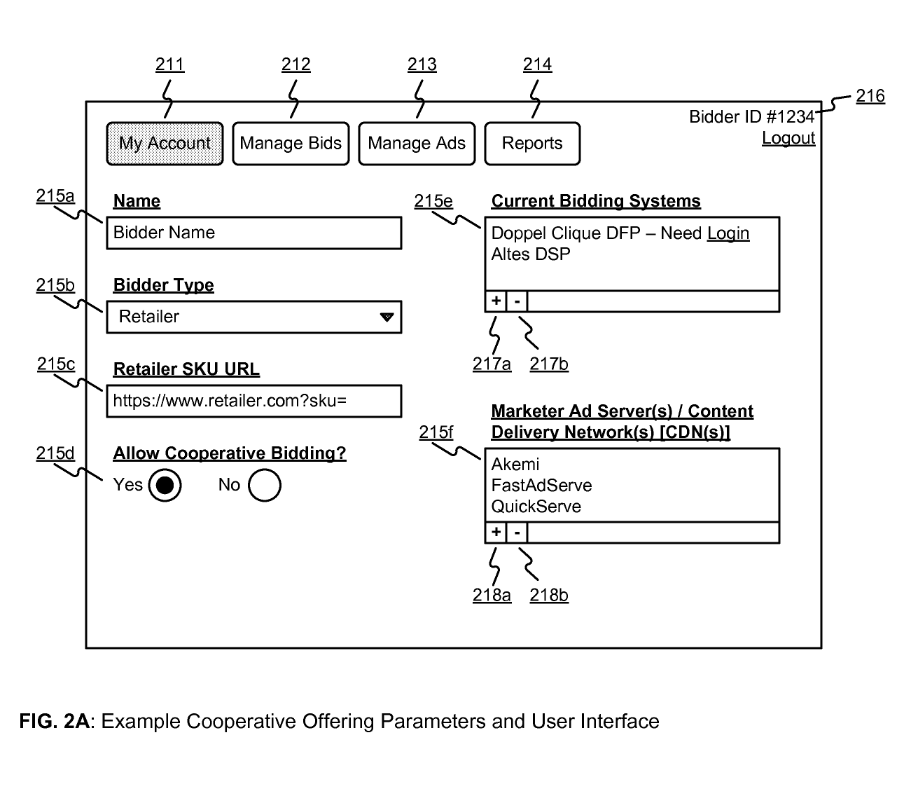

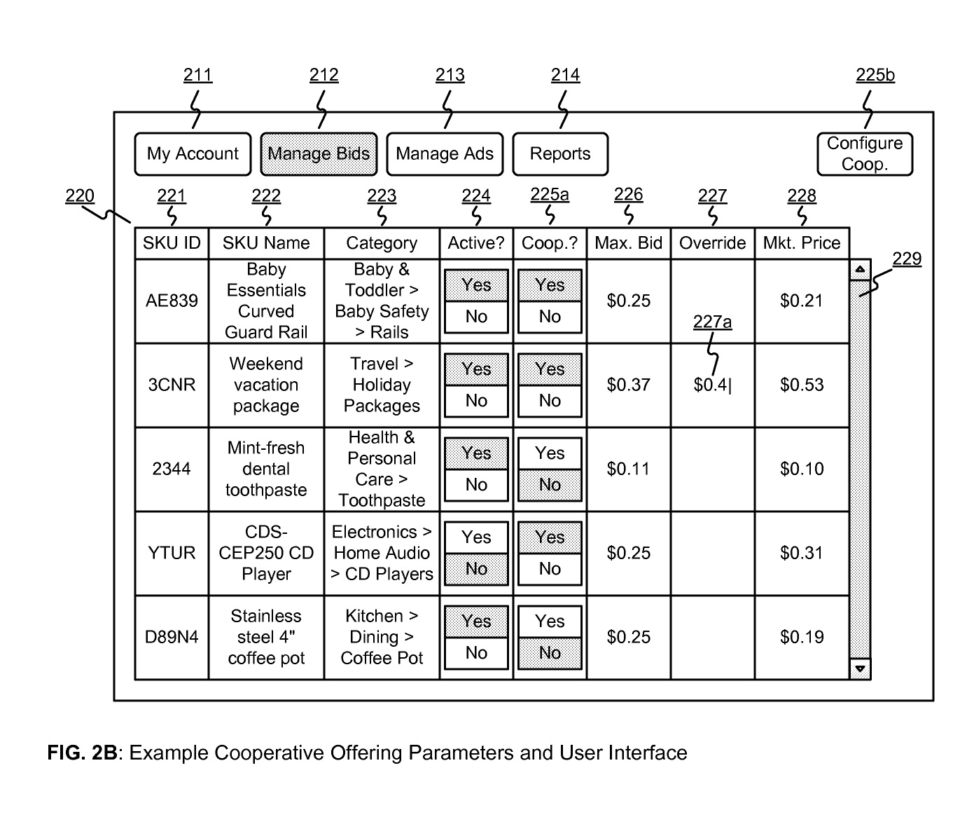

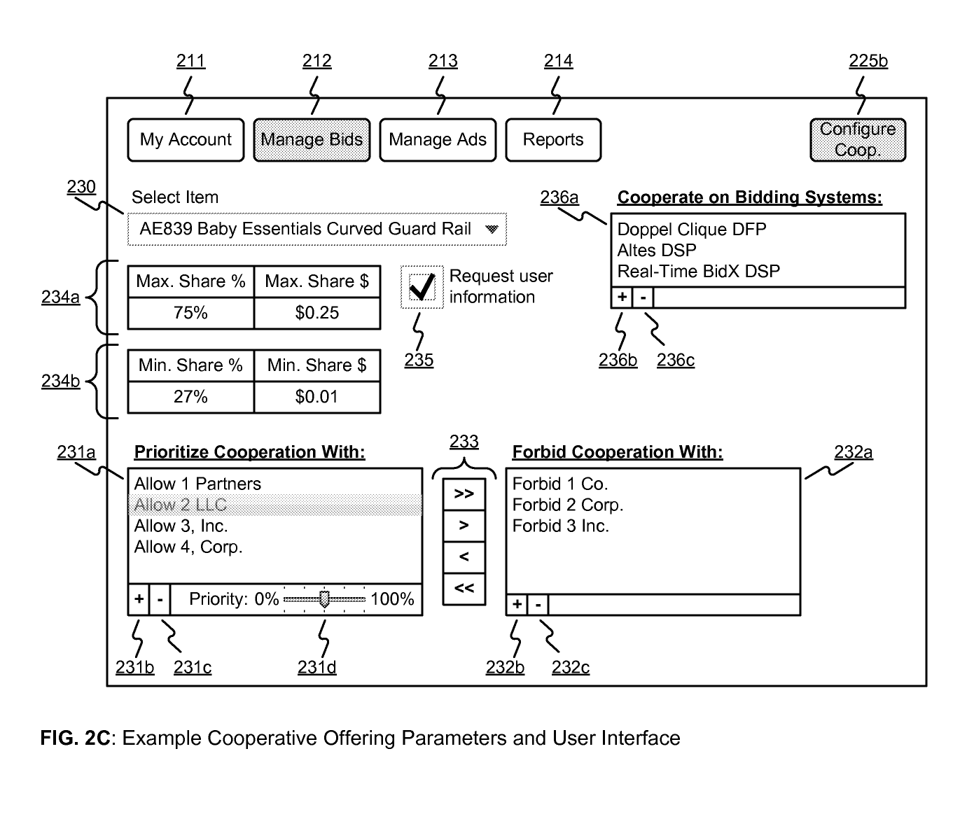

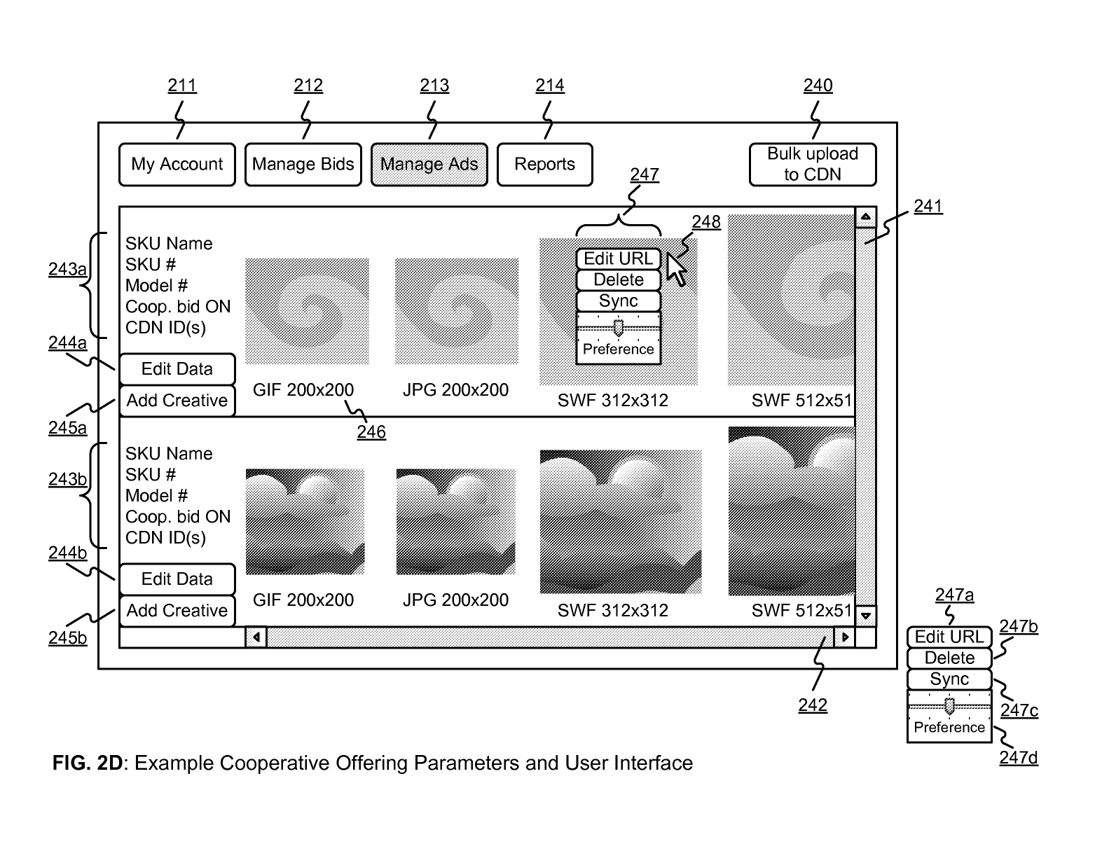

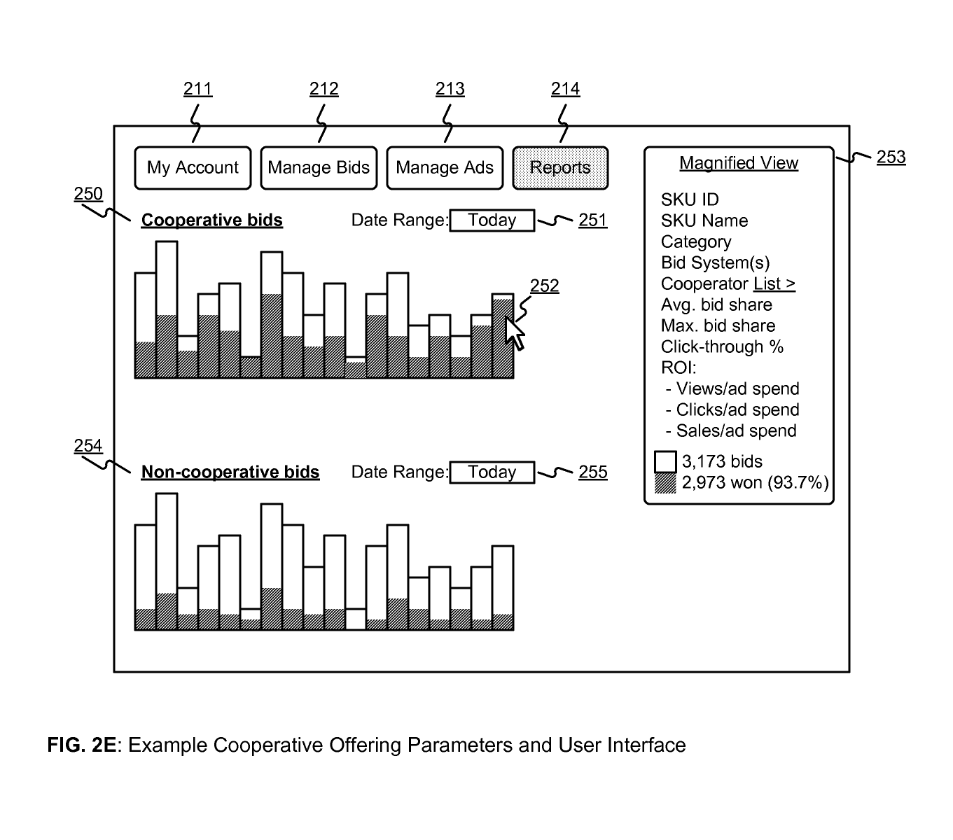

FIGS. 2A-E illustrate example cooperative offering parameters, and example user interface screens for modifying cooperative offering parameters, according to some embodiments. With reference to FIG. 2A, in some embodiments, a user interface screen may be provided to manage the account settings (see element 211) of a unique offeror (see element 216), such as a retailer, an auction bidder, a brand manager, a product manufacturer, a service provider, (e.g., hotel chain, auto dealer), etc. In the user interface screen, the offeror may be able to enter a bidder name 215a, a bidder type 215b, a uniform resource locator (URL) 215c associated with the retailer, at which items such as stock keeping units (SKUs) may be purchased, and a flag 215d that indicates whether the offeror allows the cooperative offering system to generate cooperative offers including the offeror as a participant in the cooperative offering. An item, as used in this disclosure, can be anything of value than can be bought or sold (e.g., stock keeping units (SKUs), goods, services, software/music/application downloads, online advertising space, etc.), or any entity related to such an item (e.g., manufacturers, retailers, product designers, suppliers, advertisers, website owners, website hosts, etc.).

The offeror may be able to maintain a list 215e of bidding system in which the offeror may submit bids related to the items. The user interface screen may provide graphical user interface (GUI) elements 217a-b to add or remove bidding systems from the bidding system list 215e. The offeror may be able to maintain a list 215f of marketer ad servers or content delivery networks that can provide the facility of serving ads at high bandwidth/throughput to user devices across the Internet. The user interface screen may provide graphical user interface (GUI) elements 218a-b to add or remove ad serving facility provider from the list 215f.

With reference to FIG. 2B, in some embodiments, a user interface screen may be provided to manage bids of an offeror (see element 212). For example, bidding conditions may be provided for each item in a table 220. An offeror may be able to enter an item identifier (see SKU ID 221), and provide: a description of the item (see SKU name 222), an item categorization (see category 223), a status flag indicating whether the item conditions are activated (see element 224), a flag indicating whether cooperative offering is allowed for that item (see element 225a), a GUI element that activates another user interface screen (see FIG. 2C) to provide cooperative offering parameters (see element 225b), bidding parameters such as a maximum bid 226, an override bid amount 227 (e.g., in case the offeror wishes for the maximum bid for an item to be different than for other items within the same category), and a market price 228 associated with offers related to the item. The offeror may be able to scroll through the items using a GUI element 229.

With reference to FIG. 2C, in some embodiments, a user interface screen may be provided to enter further detailed cooperative offering rules, conditions, parameters, etc. For example, an offeror can select an item using a GUI element 230. The offeror may include values related to generating cooperative offers associated with the item, such as a maximum offer share values or percentages 234a, minimum offer share values or percentages 234b, a flag 235 indicating whether the offeror would like to utilize user information in determining whether to join a cooperative offer, a list 236a of bidding system in which the offeror would like to utilize cooperative offering (bidding system may be added or removed from this list using GUI elements 236b-c), etc.

In some embodiments, the offeror can provide information on which other offerors the current offeror would like to, and would not like to, cooperate with to generate cooperative offers. In some embodiments, the offeror can include a list 231a of other offerors to cooperate with, and provide priority level values for each of the other offerors using a GUI element 231d. For example, a default value for another offeror may be 50%, and the current offeror may raise above 50%, or lower below 50%, the priority level of the other offeror, to indicate whether the offeror would prefer to, or not prefer to, cooperate with the other offeror. The user interface screen may provide graphical user interface (GUI) elements 231b-c to add or remove other offerors from the list 231a. In some embodiments, the offeror can include a list 232a of other offerors with whom the offeror forbids cooperation to generate cooperative offers. The user interface screen may provide graphical user interface (GUI) elements 232b-c to add or remove other offerors from the list 232a. The user interface screen may provide graphical user interface (GUI) elements 233 to move offerors between the lists 231a and 232a.

With reference to FIG. 2D, in some embodiments, a user interface screen may be provided to manage creative file(s) that may be used to generate promotional materials (see element 213) related to cooperative offers for the items. A creative or creative file, as used herein, may denote any image (e.g., .GIF, .JPEG, .PNG, .TIFF, etc.), animation (e.g., Adobe® Flash (.FLA), Shockwave Flash (.SWF), .GIF, etc.), audio (e.g., .MP3, .WMA. .AAC, .MP4, etc.), movie (e.g., .WMV, .MOV, .DIVX, etc.), text (e.g., ASCII, structured data such as XML, JSON, etc.), combinations thereof, or other mechanism(s) for encoding information. For example, if the cooperative offer is for purchasing display advertising space within digital media content viewed by a user on a user device, the creative file(s), e.g., element 246, may represent the advertisements that are provided for display in the display advertising space should the cooperative offer to purchase display advertising space be accepted. The user interface screen may present one or more creative file(s), e.g., element 246, associated with an item. Details of the item may be provided (see elements 243a-b), which may be edited (see GUI elements 244a-b). Additional creative file(s) may be added to the user interface and associated with the item (see elements 245a-b). In some embodiments, an additional menu 247 of GUI elements may be provided to further customize the data and creative file(s). For example, when an offeror moves a mouse pointer 248 over a creative file, a menu 247 may appear automatically. The menu 247 may include: a GUI element 247a for modifying a URL for a marketer ad/CDN server for ad-serving the creative file; a GUI element 247b for deleting the creative file, a GUI element 247c for initiating synchronization of the creative file to the appropriate marketer ad/CDN server; and a GUI element 247d for indicating a preference of the offeror that the creative file be used rather than other creative files.

With reference to FIG. 2E, in some embodiments, a user interface screen may be provided that depicts data reports (see element 214) relating to the effectiveness of the cooperative offering features of the present disclosure. For example, the user interface screen may provide a comparison of data between cooperative bids (see graph 250) and non-cooperative bids (see graph 254). For example, the graphs may depict a number of times that a (non-)cooperative offer was provided related to a particular item, and how often the offer yielded a positive result (e.g., how often the offer was accepted over other offers). GUI elements 251, 255 may be provided to modify a time period corresponding to the displayed data. When an offeror moves a mouse pointer 252 over a bar within graphs 250 or 254, a magnified view menu 253 may appear automatically providing detailed information relating to an item corresponding to that bar within the graph. The magnified view 253 may provide information about the item, as well as the efficacy of utilizing cooperative offering related to that item (see, e.g., “ROI”). While reports here are depicted as being generated according to item, reports may also be generated according to: client ID; item category; SKU; advertiser/offeror; date; geo-location; URL location; demographics, etc.

In some embodiments, an offeror may specify a return-on-investment (“ROI”) target (e.g., total, minimum, median, average, etc.) as an offer parameter. In such embodiments, the decision of whether to generate a cooperative offer, the cooperative offer value if it is decided that a cooperative offer should be generated, the cooperative offer value share assigned to one or more offerors, etc. (as discussed below in this disclosure) may be determined in part based on the ROI target. For example, the cooperative offer generation system may determine an estimate of how likely such a generated cooperative offer would be clicked by the user, an estimate of how likely the click will result in a payment transaction. Based on such estimates, the system may decide whether to generate the cooperative offer, the cooperative offer value, the cooperative offer value share, etc.

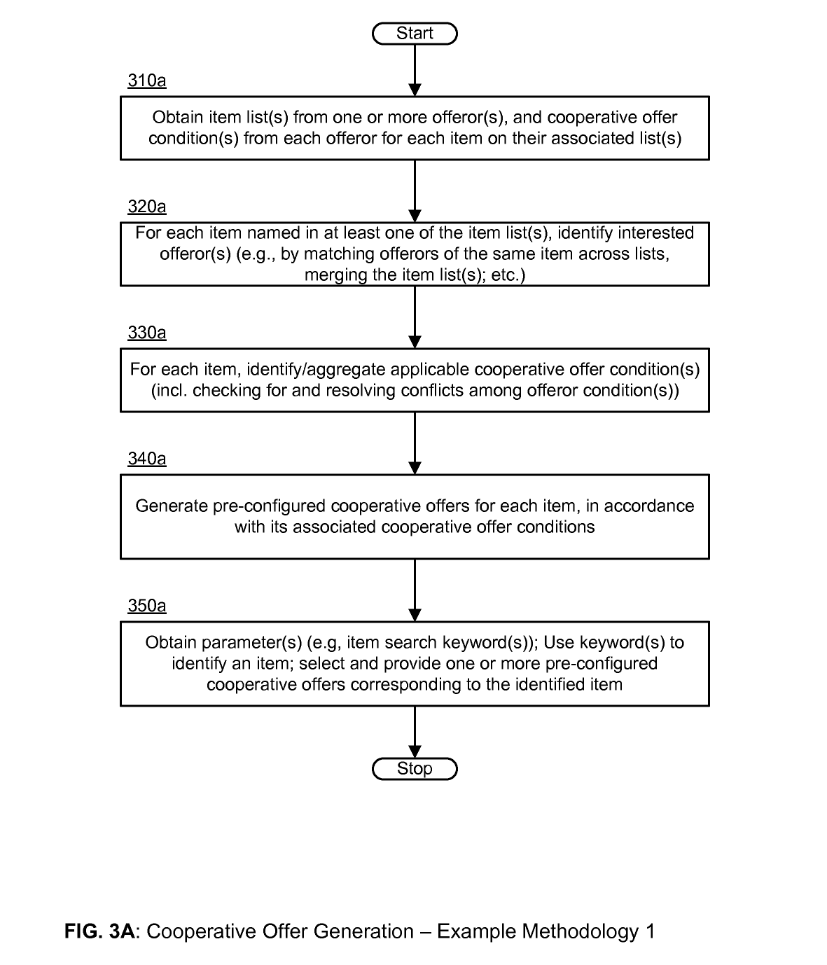

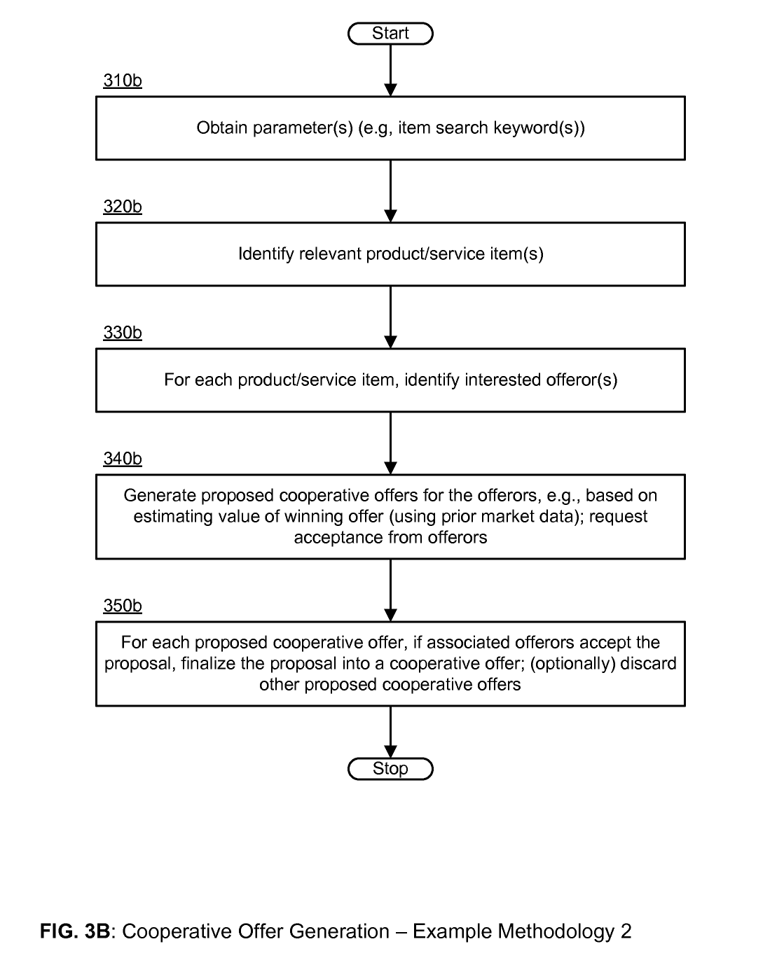

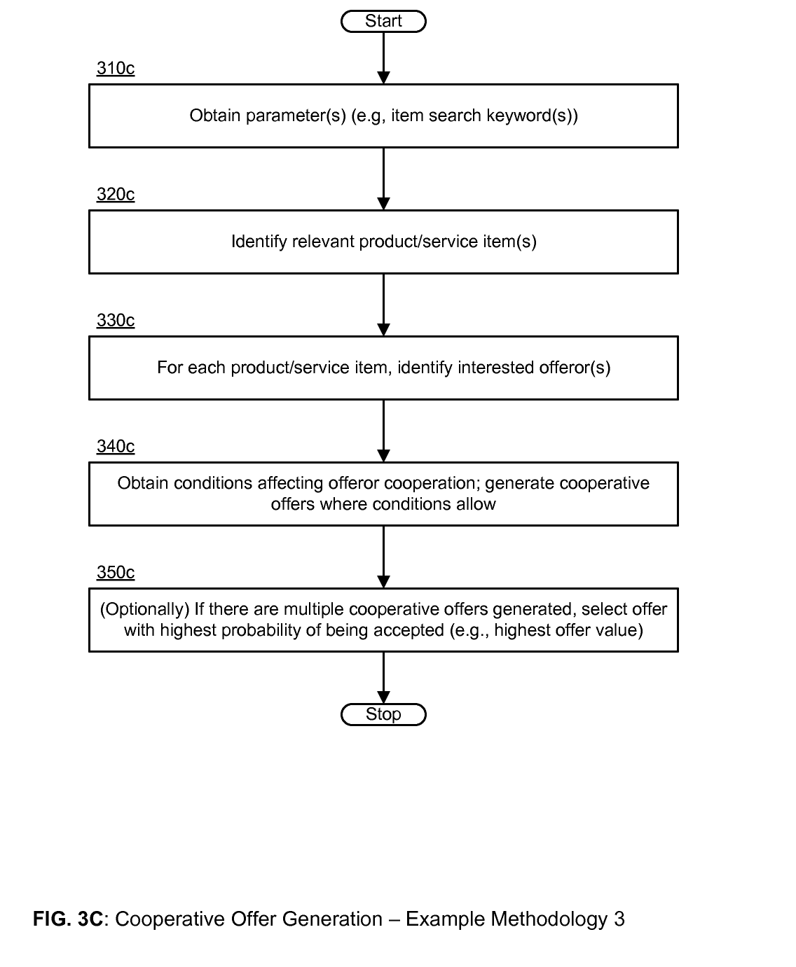

FIGS. 3A-C are flow diagrams illustrating example methodologies for generating cooperative offers, in accordance with some embodiments. With reference to FIG. 3A, in some embodiments, a computer, such as a server that is part of a demand-side platform (DSP) of a real-time bidding (RTB) system (see, e.g., RTB-DSP server(s) 406a-n) may implement a methodology for generating cooperative offers. The computer may obtain lists of items from one or more offerors, 310a. The computer may obtain a list of items in the form of structured data (such as XML, JSON, etc.), a spreadsheet, a CSV file, a text file, a data record from a relational database management system (RDBMS), etc. The computer may obtain the list via any transport mechanism that can be supported by the Internet or other communication networks, such as e-mail messages, HTTP messages, SMS messages, etc.

In some embodiments, the computer may also obtain cooperative offer conditions associated with items on a list. The cooperative offer conditions for an item listed by an offeror may define the offeror's rules, parameters, requirements, or conditions that apply to a cooperative offer, in which the offeror joins, related to the item (e.g., a bid for advertising space on a webpage to advertise the item). FIG. 2C provides examples of cooperative offer conditions related to an item. In some embodiments, the cooperative offer conditions for each item may be provided in the item list. An example XML data structure indicating an item and its associated cooperative offer conditions is provided below:

```
<! - - parameters are exemplary, and not always needed - - >
<item>
      <item_ID>AE839</item_ID>
      <item_name>Baby Essentials Curved Guard Rail</item_name>
      <offeror_ID>bidder123</offeror_ID>
      <coop_flag>ON</coop_flag>
      <coop_offer_conditions>
          <bid_systems_list>Doppel Clique DFP; Altes DSP; Real-
Time BidX DSP</bid_systems_list>
          <max_share_type>percent</max_bid_type>
          <max_share_value>75</max_bid_value>
          <min_share_type>USD</max_bid_type>
          <min_share_value>0.01</max_bid_value>
          <target_ROI_type>min</target_ROI_type>
          <target_ROI_value>$1.2; “per click”</target_ROI_value>
          <request_user_info_flag>ON</request_user_info_flag>
          <prioritize_list>“Allow 1 Partners” “75%” “Allow 2 LLC”
“60%” “Allow 3, Inc.” “55%” “Allow 4, Corp.” “35%” </prioritize_list>
          <forbid_list>“Forbid 1 Co.” “Forbid 2 Corp.” “Forbid 3 Inc.”
“offeror_ID>AE1765</offeror_ID>”</forbid _list>
      </coop_offer_conditions>
</item>
```

In some embodiments, the computer may obtain the cooperative offer conditions on-demand, rather than up front along with the item lists. For example, the computer may first determine whether an item is included in lists provided by more than one offeror. Cooperative offers could potentially be generated for such items. For such items, the computer may send requests to the two or more offerors in whose lists the item was included, requesting cooperative offer conditions for the specific item.

In some embodiments, for each item, the computer may determine whether the item is included in lists associated with more than one offeror, and identify the offerors interested in the item, 320a. For example, the computer may match offerors of the same item across lists. As another example, the computer may merge all lists it receives, and optionally sort the merged list by a unique parameter, such as an item identifier. The computer may traverse the list searching for duplicate mentions of each item identifier in the merged list. If the computer detects a duplicate mention of an item identifier, the computer may determine that more than one offeror may be interested in the item, and may identify the offerors to potentially associate together for the purpose of generating a cooperative offer related to the item.

For items eligible for cooperative offer generation, the computer may obtain the applicable cooperative offer conditions associated with each associated offeror, either from offeror conditions previously provided for the computer, or by making on-demand requests to the associated offerors for their cooperative offer conditions, 330a. In some scenarios, the cooperative offer conditions of two or more offerors may conflict with each other in such a manner that those offerors may not be associated together for the purpose of cooperative offer generation. For example, if two offerors of an item both require a minimum offer share of greater than 50% of the total offer value, their cooperative offer conditions are in an irreconcilable conflict. The computer may identify such irreconcilable conflicts, and may proceed to place the two offerors in separate cooperative offer groups, even though the offers ultimately generated may be associated with the same item. As another example, if three offerors of an item all require a minimum offer share of greater than 33% of the total offer value, the computer may determine that only two of the three offerors may be placed in the same cooperative offer group. The computer may identify two of the offerors to place together. For example, the computer may perform an analysis of compatibility of any other cooperative offer conditions provided by the three offerors to determine which two offerors may best be grouped together. For example, the computer may create all possible permutations of groups, and may identify the permutation that results in cooperative offers that have the highest chances of winning (e.g., being accepted over other competing offers). As another example, the computer may randomly select a permutation, and determine whether the permutation violates any of the cooperative offer conditions provided by the offerors. If no cooperative offer condition is violated, the computer may utilize the selected permutation, and generate cooperative offer groups accordingly.

Having identified a cooperative offer group for an item, the computer may generate a cooperative offer in accordance with the cooperative offer conditions associated with the offerors in the cooperative offer group, 340a. In some embodiments, the cooperative offer may be generated before a request for such a cooperative offer is received. Such a cooperative offer may be considered “pre-configured” for delivery upon request. If a cooperative offer is generated after a first request, but before a second request, the cooperative offer may be considered “pre-configured” for the second request. The computer may obtain a request for the pre-configured cooperative offer. For example, the computer may obtain one or more item search keywords, 350a. Using the item search keywords, the computer may determine that the pre-configured cooperative offer should be provided in response to obtaining the item search keywords. Accordingly, the computer may select and provide the pre-configured cooperative offer.

With reference to FIG. 3B, in some embodiments, cooperative offers may be generated on-demand rather than being pre-configured. In an example methodology, a computer may obtain one or more item search keywords, 310b. Using the item search keywords, the computer may identify one or more items that are relevant to the items search keywords, 320b. The computer may select one of the identified items, and identify offerors that may be interested in the item (e.g., for advertising it), 330b. The computer may generate one or more proposed cooperative offers related to the selected item, 340b. For example, the computer may obtain one or more guidelines, rules, parameters, or conditions according to which to generate cooperative offers, and may apply these to generate one or more cooperative offers. The computer may provide to the offerors grouped together to generate the proposed cooperative offer the generated proposed cooperative offers, data to identify the offerors grouped together, and/or data to identify the offeror share values, total offer value, or any other cooperative offer parameters, 340b. The computer may then obtain responses to the proposed cooperative offer from each of the offerors proposed to be grouped together, 350b. If all of the offerors accept the proposal, the computer may finalize the proposal into a cooperative offer. The computer may discard any proposals that did not receive acceptance of all associated offerors. The computer may provide the finalized cooperative offer(s) in response to the obtained items search keywords.

With reference to FIG. 3C, in some embodiments, cooperative offers may be generated on-demand via another example methodology. A computer may obtain one or more item search keywords, 310c. Using the item search keywords, the computer may identify one or more items that are relevant to the items search keywords, 320c. The computer may select one of the identified items, and identify offerors that may be interested in the item (e.g., for advertising it), 330c. The computer may obtain cooperative offer conditions associated with the identified offerors for the selected item, e.g., as previously provided by the offerors, or on-demand from the interested offerors. The computer may generate one or more cooperative offer(s) in accordance with the cooperative offer conditions associated with the offerors in the cooperative offer group, 340c. For example, the computer may group the interested offerors for an item according to all possible permutations of groups, and then eliminate those permutations where an irreconcilable conflict exists between two or more offerors in a group in the permutation. In some scenarios, this procedure may result in multiple cooperative offers being generated for the item. In some embodiments, the computer may provide all the cooperative offers. In alternate embodiments, the computer may select the cooperative offer that has the highest chance of winning (e.g., being accepted over other competing offers), and provide the selected cooperative offer, 350c.

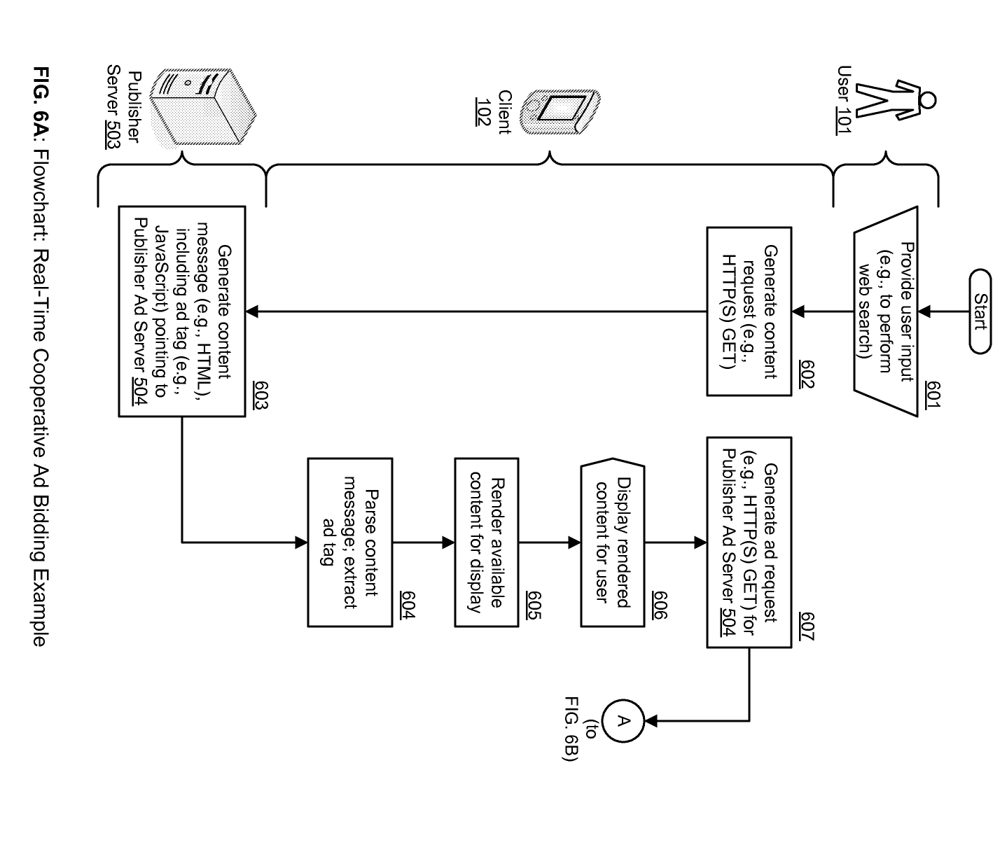

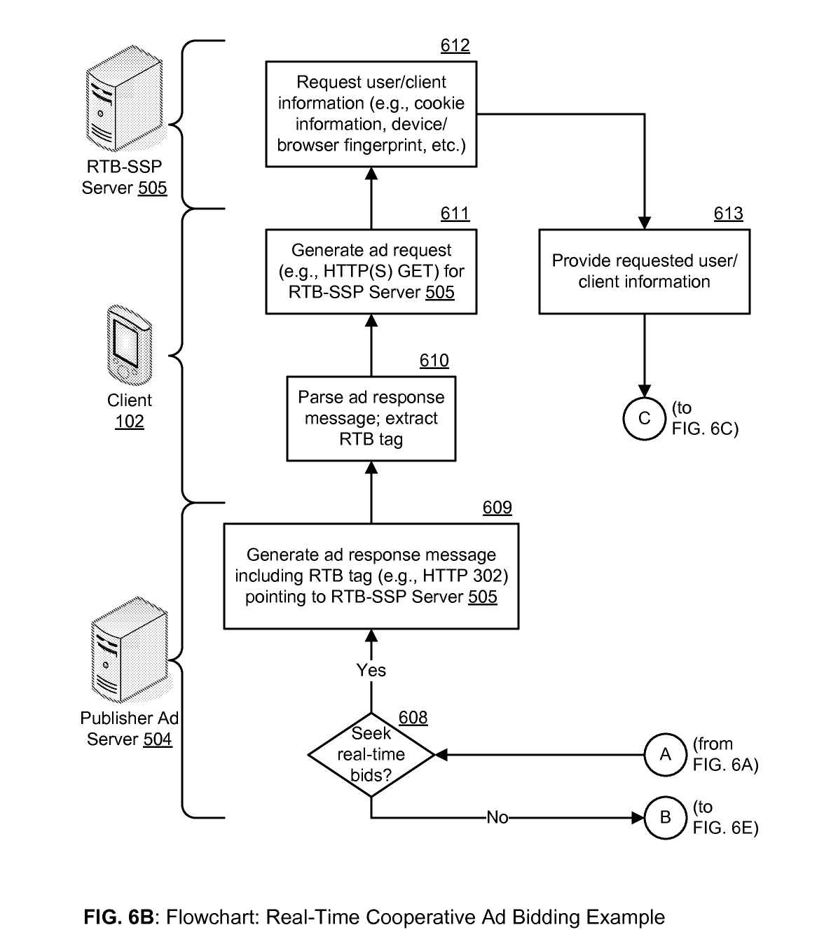

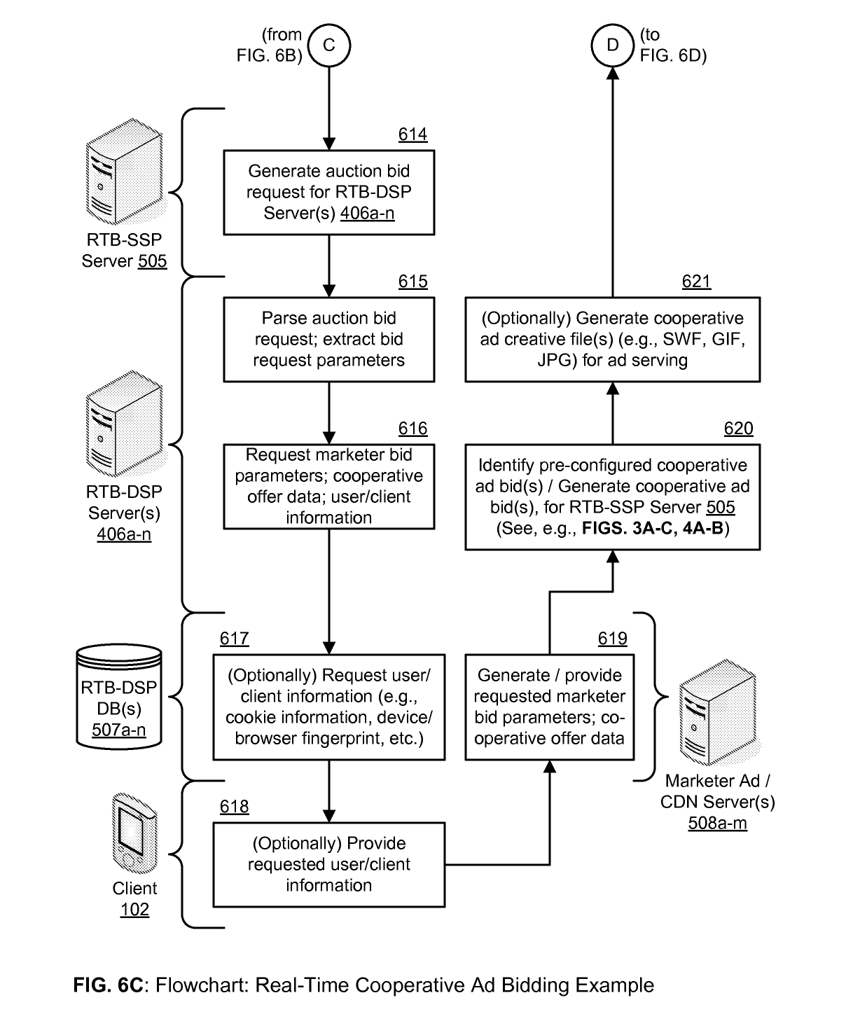

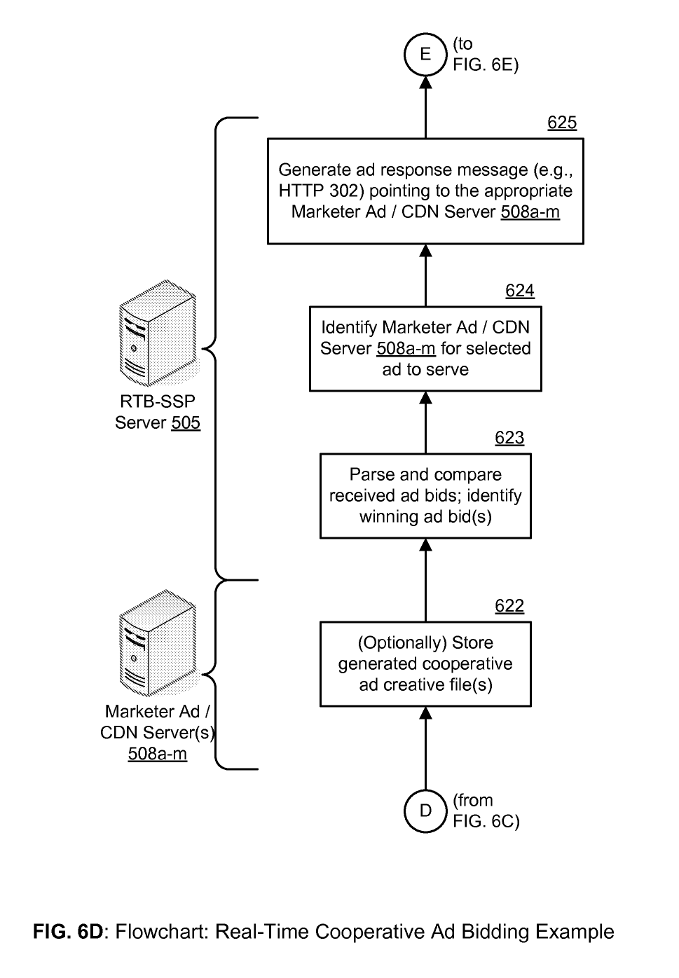

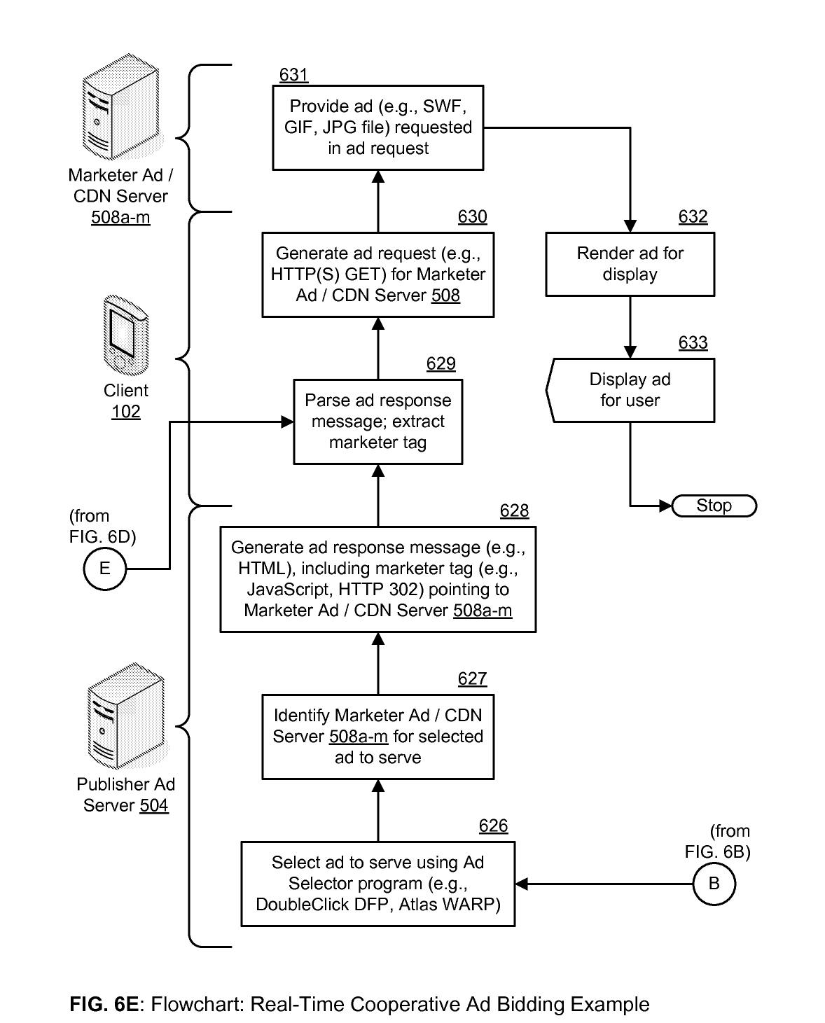

FIGS. 4A-B are flow diagrams illustrating an example procedure for generating cooperative offers, consistent with the methodology illustrated in FIG. 3A. With reference to FIG. 4A, in some embodiments, a computer, such as a server that is part of a demand-side platform (DSP) of a real-time bidding (RTB) system (see, e.g., RTB-DSP server(s) 406a-n) may implement a methodology for generating cooperative offers. In some embodiments, the computer may obtain a request to make an offer, 411. For example, in the context of auctioning of online advertising space, a supply-side platform (SSP) server within a RTB system may indicate that an advertising space is for sale, e.g., an auction of the advertising space on a user's webpage has been initiated, and may request bids to purchase the advertising space. The RTB-SSP server may provide the computer information relevant to the auction. For example, the RTB-SSP server may provide the computer offer request parameters (e.g., FIG. 6C, 615). In general, a parameter can be any data field similar to those disclosed herein, for example, such as an item identifier, selection/search keyword, end-user ID, user attribute, user profile data, taxonomy data, website context (e.g., site URL, page metadata), browser fingerprint data, etc.

The computer may attempt to identify items that are relevant to the request to make the offer. For example, in the context of auctioning of online advertising space, the computer may attempt to identify one or more items that may be advertised in the advertising space that is being auctioned. The computer may also determine whether a bid for advertising any of the identified items may be generated through cooperative offer generation by grouping two or more offerors that may be interested in advertising the same item in the advertising space being auctioned.

Accordingly, in some embodiments, the computer may obtain marketer/offeror offer bid parameters (e.g., FIG. 6C, 619), such as user data (e.g., retrieved from a cookie stored on a user device such as client 102), Bidder ID, Bidder data, SKU ID, SKU name, SKU description, SKU category, max. bid, bid override, cooperative bid flag, maximum bid share values, minimum bid share values, bidding system in which cooperative offering is acceptable, cooperation prioritization data, cooperation forbidden data, etc. (see FIGS. 2A-C for example marketer/offeror offer bid parameters), 412.

The computer may identify the items that are relevant to the request to make the offer, 414. For example, the computer may use the offer request parameters (e.g., as obtained at step 411) to search through the marketer offer bid parameters (e.g., as obtained at step 412), to identify any matches. In the context of auctioning of online advertising space, the computer may use the selection keywords, end-user ID, user attributes, user website context (e.g., site URL, page metadata, etc.) to identify SKU ID(s) of SKUs that may be advertised in the advertising space being auctioned.

In some embodiments, the computer may filter these relevant items by eligibility for cooperative offer generation, such that only those relevant items remain that are also eligible for cooperative offer generation, 415. For example, the computer may identify items that are eligible for cooperative offer generation. In some embodiments, the computer may determine whether the item is included in lists associated with more than one offeror, and identify the offerors interested in the item. In the context of auctioning of online advertising space, the computer may determine the SKU ID(s) that are eligible for cooperative offer generation. For this, the computer may determine for which SKU ID(s) the cooperative bid flag is set to “ON.” For example, the computer may identify those items that appear in both the “relevant” and “eligible” categories. In the online advertising space auctioning example, the computer may use the results of the identification process (e.g., list of cooperative offering-eligible SKU ID(s)) to filter the relevant SKU ID(s) list created in step 414.

With reference to FIG. 4B, in some embodiments, the computer may generate cooperative offers for each of the remaining items. For each remaining item, the computer may identify the interested offerors, and group them together into cooperative offeror groups, 416-417. In the online advertising space auctioning example, the computer may identify one or more bidder ID(s) associated with each remaining SKU ID, 416. The bidders corresponding to these bidder ID(s) may be grouped together appropriately into cooperative offeror groups. In some scenarios, the same SKU may be labeled with different SKU ID(s), e.g., if the labeling or identification conventions are different among the different marketers. Thus, cooperative offeror groups associated with different SKU IDs may in actuality all be interested in offering the same SKU. Thus, in some embodiments, the computer may compare the characteristics of the SKUs corresponding to the SKU ID(s), and determine whether the SKUs match even if the SKU IDs do not match. For example, the computer may utilize semantic search techniques to identify SKUs that are the same even though they have different SKU IDs, 417. Accordingly, the computer may group all offerors that are interested in the same SKU (even if they identify the same SKU with different SKU IDs). As discussed above with reference to FIG. 3A, the computer may identify irreconcilable conflicts among the marketer/offeror offer bid parameters of the offerors, and create cooperative offeror groups in a manner that avoids such conflicts.

The computer may select each item that has a cooperative offeror group associated with it, 418, and proceed to generate one or more cooperative offers associated with the item. For example, the computer may identify the offerors (e.g., by bidder ID) that are grouped together for the selected item, 419. The computer may identify the maximum offer/bid share for each offeror, 420. In some embodiments, the computer may also estimate a lowest-possible winning offer/bid (e.g., using prior market data—see FIG. 2B, 228), 421. The computer may determine a cooperative offer/bid amount, and assign an offer/bid share to each offeror in the group (e.g., based on the maximum offer/bid share for each offeror, and the winning bid estimate), 422. The computer may apply any other cooperative offer conditions imposed by any of the offerors in the group; the use of maximum offer/bid shares and winning offer/bid estimates are exemplary only and non-limiting. Accordingly, the computer may generate the cooperative offer (e.g., using one or more creatives (see FIG. 2D) from one or more of the offerors), and also collect data associated with the cooperative offer, e.g., offer request parameters, text for building the offer for display, offeror URLs to include in the offer, CDN URL(s) for images, etc. (see FIGS. 2A-E for exemplary cooperative offer data), 423. As example cooperative offer, written substantially in the form of an XML data structure, is provided below:

```
<! - - parameters are exemplary, and not always needed - - >
<coop_offer>
      <bid_protocol_version>RTB 1.1</bid_protocol_version>
      <bid_req_ID>ANB234</bid_req_ID>
      <offeror_ID>{bidder123; bidder 135; bidder 345}</offeror_ID>
      <bid_slot>1 </bid_slot>
      <bid>max_cpm_micros:100000</bid>
      <ad>
        <html_snippet>”<img
        src=‘imgsrv.com/12'/>”</html_snippet>
        <click_through_URL>”r.cdn.com?12”</click_through_URL>
        <creative_ID>12-ANB12</creative_ID>
        <vendor_type>mixed</vendor_type>
        <category>3</category>
      </ad>
</coop_offer>
```

The computer may perform such a procedure for each item that is relevant and eligible for cooperative offer generation (see step 424). In some embodiments, the computer may optionally select a cooperative offer for each item that is of the highest offer value among the cooperative offers associated with the item, 425. The computer may store (e.g., for later retrieval), or provide the generated cooperative offer(s), 426.

In some embodiments, for those items that are not eligible for cooperative offer generation, the computer may generate individually sponsored offers/bids, which may compete against the generated cooperative offers.

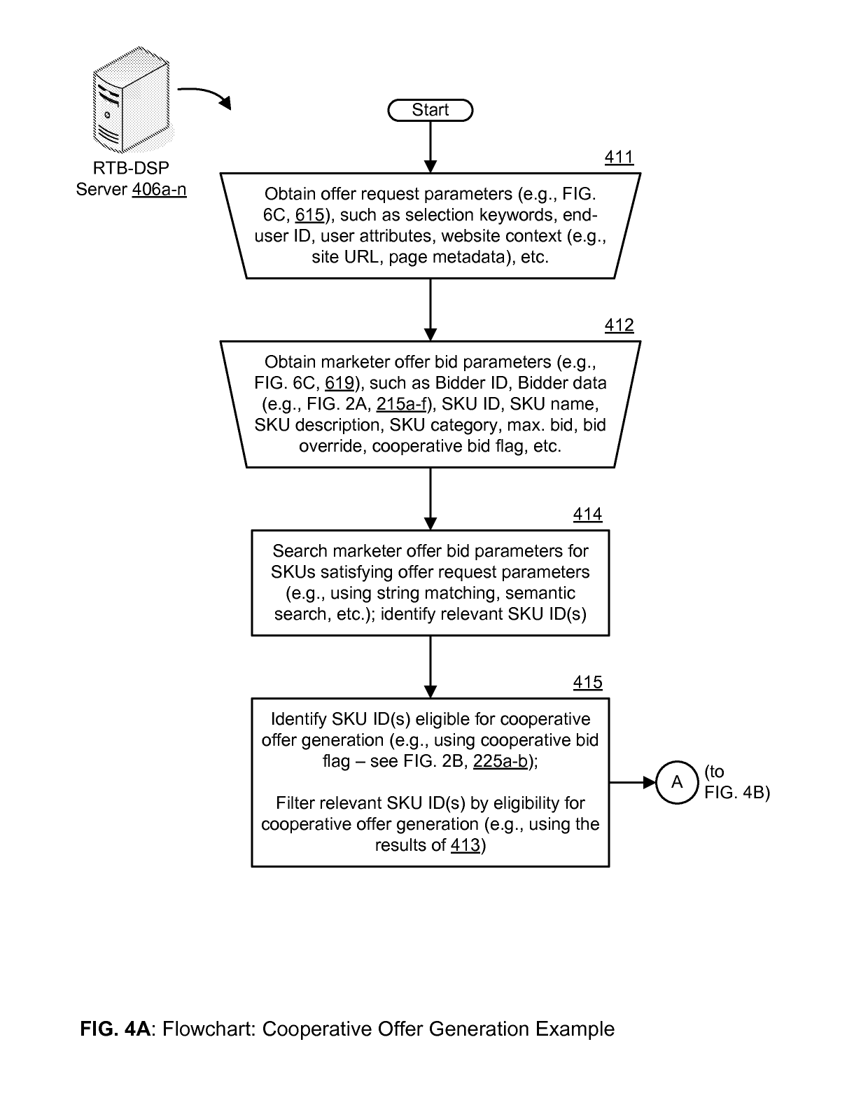

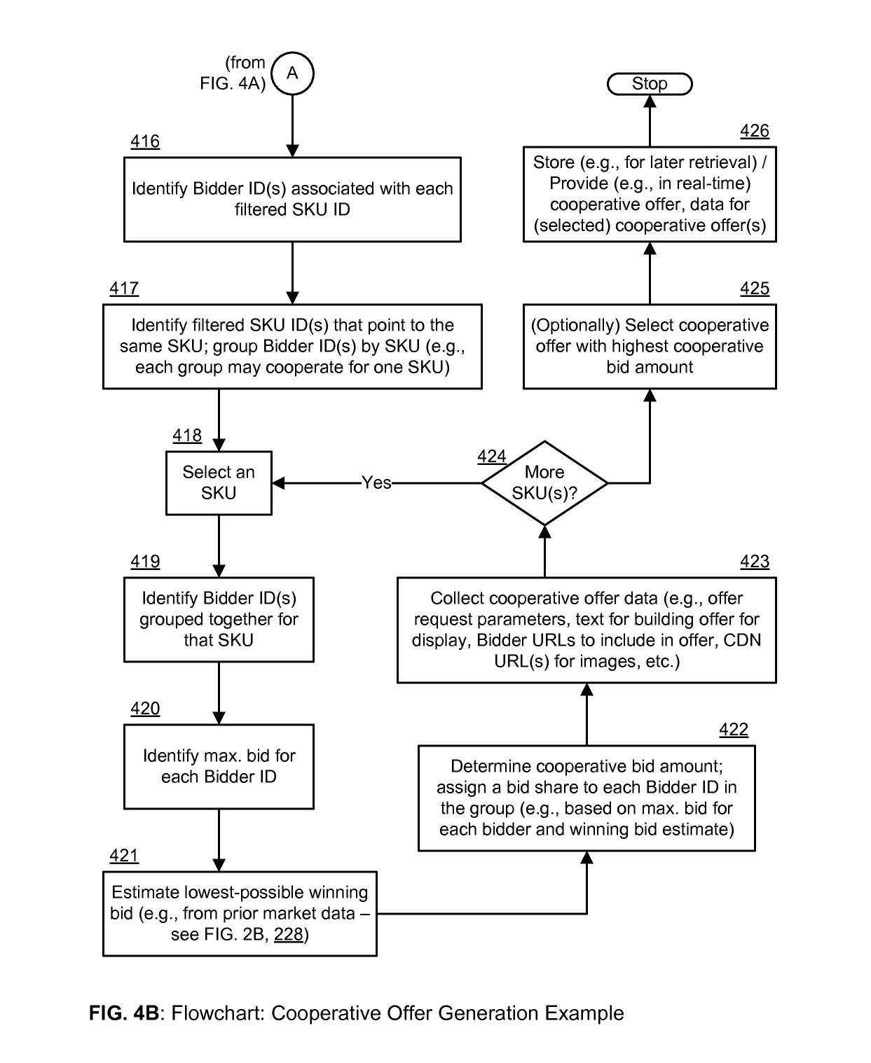

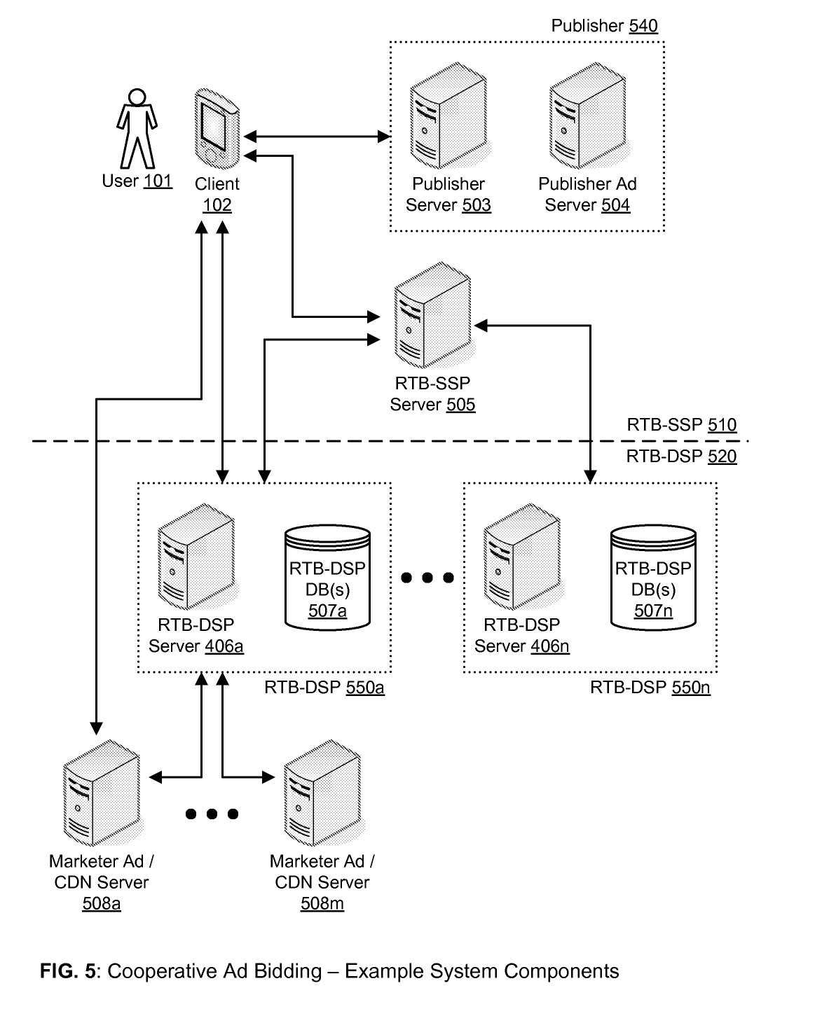

FIG. 5 is a block diagram of example components for a cooperative advertisement bidding system, according to some embodiments. In some embodiments, a real-time bidding (RTB) system may include a supply-side platform (SSP) 510 and a demand-side platform (DSP) 520. The SSP may provide requests for bids, and the DSP may provide bids to the SSP in response to the request for bids. For example, a user 101 may be using a client 102 to retrieve digital media content published by a publisher 540. The publisher 540 may utilize a publisher server 503 that stores the digital media content. The publisher 540 may also utilize a publisher ad server 504. For example, the client 102 may request digital media content (see, e.g., FIGS. 2A-E) from the publisher server 503. The publisher server 503 may serve the client 102 with the digital media content, which may include in it a hypertext reference (“href”) configured to redirect the client 102 to the publisher ad server 504 for an advertisement that is to be displayed in an advertisement space reserved within the digital media content. The client 102 may utilize the hypertext reference to request the publisher ad server 504 for an advertisement. The publisher ad server 504 may determine that the advertisement to be served to the client 102 should be selected using an auction, e.g., the advertising space reserved within the digital media content should be auctioned to a highest bidder. The publisher server 504 may redirect the client 102 to a RTB-SSP server 505 that may be configured to conduct the auction. In response to the client 102 requesting the RTB-SSP server 505 for an advertisement to place in the advertising space, the RTB-SSP server 505 may request the RTB-DSP servers 406a-n for bids to purchase the advertising space.

Some RTB-DSP servers, e.g., 406n, may not be configured for cooperative offer generation, and thus may provide individually sponsored bids. The RTB-DSP server 406n may query a database, e.g., RTB-DSP DB(s) 507n, for bids to provide in response to the RTB-SSP server 505 request for bids. In some embodiments, a RTB-DSP server, e.g., 406a, may be configured to implement cooperative offer generation. The RTB-DSP server may utilize data stored in a database, e.g., RTB-DSP DB(s) 507a, and/or data obtained on-demand from client 102, or from marketer ad/content delivery network (CDN) server(s) 508a-m, to generate cooperative bids (e.g., where two or more marketers associated with the marketer ad/content delivery network server(s) 508a-m cooperate with each other). The RTB-DSP server 406a may provide the cooperative bid(s) to the RTB-SSP server 505. The RTB-SSP server 505 may identify a winning bid, which may be a cooperative bid submitted by the RTB-DSP server 406a. The RTB-DSP server 406a may also provide a hypertext reference to a creative file (see, e.g., FIG. 2D, 246) stored at a marketer ad/CDN server 508a-m to the RTB-SSP server 505. The RTB-SSP server 505 may return the hypertext reference to the creative file to the client 102 in response to the client 102 request for an advertisement to place in the advertising space. The client may utilize the hypertext reference provided by the RTB-SSP server 505 to request the marketer ad/CDN server 508a-m for the creative file, which the marketer ad/CDN server 508a-m may provide in response. The client 102 may render the creative file and display it in the advertisement space reserved within the digital media content.

FIGS. 6A-E are flow diagrams illustrating an example procedure for real-time cooperative advertisement bidding, in accordance with some embodiments. With reference to FIG. 6A, in some embodiments, a user 101 may provide user input into a client 102 to retrieve digital media content, 601. For example, the user may utilize a user interface screen displayed on the client 102 similar to one of the user interface screens depicted in FIGS. 2A-E. The client 102 may generate a content request, 602. For example, the client may provide a HTTP(S) GET request to a publisher server 503 hosting the requested content. For example, the publisher server 503 may be a web server, a search engine server, a social networking server, a mobile application back-end server, etc. The publisher server may generate a content message in response to the content request, 603. For example, the publisher server 503 may generate a HTTP(S) 200 OK message, and include HTML content in the body of the HTTP(S) 200 OK message. In some embodiments, the content may include an ad tag pointing to the publisher ad server 504. For example, the ad tag may be implemented using JavaScript. An example pseudo-code listing, substantially in the form of JavaScript, for implementing an ad tag, is provided below:

<script type=“text/javascript”>
var ord = Number(ord) || Math.floor(Math.random( )*10e12);
document.write(‘<a href=“http://ad.publisher.com/get?pos=top;
tile=tile_number;sz=width×height” target=“_blank”><img src=
“http://ad.publisher.com/get?pos=top;tile=tile_number;sz=width×height”
/></a>’);
</script>
<noscript>
<a href=“http://ad.publisher.com/get?pos=top;tile=tile_number;sz=
width×height“target=“_blank”>
<img src=“http:// ad.publisher.com/get?pos=top;tile=tile_number;sz=
width×height”/>
</a>
<! - - script parameters are exemplary, and not always needed - - >
</noscript>

The client 102 may receive the requested content from the publisher server 503, and may parse the message content. For example, the client 102 may utilize a browser application, such as Microsoft Internet Explorer, Mozilla Firefox, Google Chrome, Apple Safari, Opera, etc., to parse the message content and extract the ad tag, 604. The client 102 may render the content for display (e.g., using a browser rendering engine), 605, and display the rendered content for the user, 606. The client 102 may also extract a hypertext reference from the ad tag that points to the publisher ad server 504. The client may generate for the publisher ad server 504 an ad request, 607. For example, the client 102 may generate a HTTP(S) GET request that is substantially similar to the example pseudo-code listing provided below:

GET /get?pos=top;tile=1 ;sz=640×480 HTTP/1.1
Host: http://ad.publisher.com

With reference to FIG. 6B, in some embodiments, the publisher ad server 504 may receive the ad request from the client 102, and determine whether to seek real-time bids to purchase the advertising space being offered, 608.

If the publisher ad server 504 determines not to seek bids (see 608, option “No”), the publisher ads server 504 may skip the real-time bidding process, and generate an ad response message on its own, including a hypertext reference to a creative file (e.g., stored at a marketer ad/CDN server 508a-m), and transmit the ad response message to the client 102 for further processing (see FIG. 6E). With reference to FIG. 6E, the publisher server 504 may select an ad to serve using an Ad Selector program (e.g., DoubleClick, Atlas WARP, etc.), 626. The publisher server may identify the hypertext reference to the marketer ad/CDN server(s) 508a-m at which the creative file(s) to be displayed are stored, 627. The publisher server 504 may generate an ad response message, e.g., a HTTP(S) 200 OK message, including the hypertext reference to the appropriate marketer ad/CDN server(s) 508a-m, and provide the ad response message to the client 102 (see step 628).

Returning to FIG. 6B, if the publisher ad server 504 determines that it should seek bids (see 608, option “Yes”), the publisher ads server 504 may generate an ad response message including a RTB tag that includes a hypertext reference to RTB-SSP server 505, e.g., a HTTP(S) 302 Redirect message, 609. The publisher ad server 504 may provide the ad response message to the client 102. The client 102 may parse the ad response message and extract the RTB tag, 610. The client 102 may use the hypertext reference to RTB-SSP server 505 to generate an ad request for the RTB-SSP server 505, e.g., a HTTP(S) GET message, 611. The client 102 may send the ad request message to the RTB-SSP server 505. The RTB-SSP server 505 may optionally request user/device information from the client 102 (e.g., cookie information, device/browser fingerprint, etc.), 612. Such user/device information may be utilized as one or more marketer/offeror offer bid parameters for cooperative offer generation and/or valuation. For example, the RTB-SSP server 505 may provide a HTTP(S) POST message to the client 102 requesting the information in the body of the message. In response, the client 102 may provide the requested information to the RTB-SSP server 505, e.g., in a HTTP(S) POST message, 613. In some embodiments, the client 102 may provide the user/device information to the RTB-SSP server 505 without the RTB-SSP server 505 having to request the information. For example, the client 102 may provide the user/device information along with the ad request message to the RTB-SSP server 505.

With reference to FIG. 6C, in some embodiments, the RTB-SSP server 505 may generate an auction bid request for the RTB-DSP server(s) 406a-n. For example, the RTB-SSP server 505 may generate HTTP(S) GET messages for each of the RTB-DSP server(s) 406a-n, including the user/device information and/or media content-related information (e.g., site URL), 614. The RTB-DSP server(s) 406a-n may parse the auction bid requests, and extract bid request parameters from the message, 615. For example, the RTB-DSP server(s) 406a-n may be capable of executing commands implemented in Hypertext Preprocessor (PHP) scripting language, and may utilize the http_parse_message( ) PHP routine to parse the received auction bid request from the RTB-SSP server 505. In some embodiments, one or more of the RTB-DSP server(s) 406a-n may request marketer bid parameters from one or more markets ad/CDN server(s) 508a-m, and/or cooperative offer data from RTB-DSP DB(s) 507a-n, and/or user/client information from client 102 (see step 616). The RTB-DSP DB(s) 507a-n, client 102, and marketer ad/CDN server(s) 508a-m may provide the requested information, 617-619.

In one embodiment, using the obtained information, the RTB-DSP server(s) 406a-n may identify pre-configured cooperative ad bid(s) that may be utilized to respond to the auction bid request received from the RTB-SSP server 505 (see step 620). Such pre-configured ad bid(s) may have been generated previously using the methodology previously described with reference to FIG. 3A, and/or using the procedure described with reference with FIGS. 4A-B. In an alternate embodiment, the RTB-DSP server(s) 406a-n may invoke a procedure similar to the procedure described previously with reference to FIGS. 4A-B, to generate cooperative ad bid(s) for responding to the auction bid request received from the RTB-SSP server 505.

Also, optionally, the RTB-DSP server(s) 406a-n may generate cooperative ad creative file(s) (e.g., SWF, GIF, JPG, etc.) for ad serving, 621. For example, the RTB-DSP server(s) 406a-n may combine creative files from one or more of the marketers that cooperated to generate the cooperative ad bid(s) into a composite creative file for serving to client 102 and displayed for the user in the advertising space reserved within the digital media content. With reference to FIG. 6D, in some embodiments, the RTB-DSP server(s) 406a-n may provide the generated cooperative ad creative file(s) to marketer ad/CDN server(s) 508a-m. The marketer ad/CDN server(s) 508a-m may store the obtained cooperative ad creative file(s), 622. In such embodiments, the ad bid(s) provided by the RTB-DSP server(s) 406a-n to the RTB-SSP server 505 may include hypertext references to the creative file(s) stored at either the RTB-DSP server(s) 406a-n, and/or the marketer ad/CDN server(s) 508a-m.

The RTB-SSP server 505 may obtain the ad bid(s) from the RTB-DSP server(s) 406a-n, and parse and compare the received ad bid(s), 623. For example, the ad bid(s) may be provided by the RTB-DSp server(s) 406a-n in the form of HTTP 200 OK message(s), with the ad bid data provided in the body of the message. The RTB-SSP server 505 may be capable of executing commands implemented in Hypertext Preprocessor (PHP) scripting language, and may utilize the http_parse_message( ) PHP routine to parse the received ad bid(s). The RTB-SSP server 505 may identify the winning ad bid(s) (assuming that one or more advertising spaces may be reserved within the digital media content being display by the client 102, 623. For the winning bid(s), the RTB-SSP server 505 may identify the hypertext reference to the RTB-DSP server(s) 406a-n, and/or the marketer ad/CDN server(s) 508a-m at which the creative file(s) to be displayed are stored, by parsing the received ad bid message(s) from the RTB-DSP server 406a-n (see step 624). The RTB-SSP server 505 may generate an ad response message, e.g., a HTTP(S) 200 OK message, including the hypertext reference to the appropriate RTB-DSP server(s) 406a-n, and/or the marketer ad/CDN server(s) 508a-m, and provide the ad response message to the client 102 (see step 625).

With reference to FIG. 6E, in some embodiments, the client 102 may parse the ad response message and extract the marketer tag including the hypertext reference to the creative file that is to be displayed in the advertising space reserved within the digital media content, 629. For example, the client 102 may utilize a browser engine, e.g., Microsoft Internet Explorer, Google Chrome, Mozilla Firefox, Apple Safari, etc., to parse the ad response message. The client 1023 may generate an ad request to provide to the appropriate marketer ad/CDN server(s) 508a-m, e.g., a HTTP(S) GET message, 630. In response, the marketer ad/CDN server(s) 508a-m may provide the requested creative file(s) to the client 102 (see 631). The client may obtain the creative file(s), render the creative file content, 632, and display the creative file as an ad for the user, 633.

Illustrative embodiments of the present disclosure are listed below. In one embodiment, a cooperative offer generating system is disclosed, comprising: a processor; and a memory storing processor-executable instructions comprising instructions for: obtaining one or more keywords; identifying an item related to the one or more keywords; determining a plurality of offerors corresponding to the item; obtaining cooperative offer parameters for the offerors; generating a cooperative offer related to the item, including: determining a cooperative offer value, and determining a cooperative offer value share for at least one of the offerors; and providing the generated cooperative offer. In some embodiments, the cooperative offer is an online advertisement bid to advertise the item. In some embodiments, the memory further stores instructions for: obtaining an offer request; and providing the generated cooperative offer after obtaining the offer request. In some embodiments, the memory further stores instructions for: obtaining one or more other offers; combining the generated cooperative offer with the one or more other offers to generate a consolidated offer; and providing the generated consolidated offer. In some embodiments, the memory further stores instructions for: retrieving the generated cooperative offer from storage. In some embodiments, the instructions are configured for generating the cooperative offer substantially in real-time after obtaining the offer request. In some embodiments, the instructions for obtaining the cooperative offer parameters comprise instructions for: retrieving the cooperative offer parameters from storage. In some embodiments, the instructions for obtaining the cooperative offer parameters comprise instructions for: providing a request for the cooperative offer parameters to one of: a client apparatus; and a server associated with at least one of the plurality of offerors. In some embodiments, the memory further stores instructions for: providing a uniform resource locator for an advertisement corresponding to the cooperative offer. In some embodiments, the memory further stores instructions for: deducting the cooperative offer value share from an account associated with the at least one of the offerors.

In some embodiments, the instructions for providing the generated cooperative offer comprise instructions for: identifying a network address for a real-time bidding server; and providing the generated cooperative offer for the real-time bidding server using the identified network address. In some embodiments, the memory further stores instructions for: obtaining an indication from the real-time bidding server that the cooperative offer is accepted; and determining the cooperative offer value share after obtaining the indication from the real-time bidding server that the cooperative offer is accepted. In some embodiments, the memory further stores instructions for: generating a report related to the item; and storing the generated report. In some embodiments, the memory further storing instructions for: providing a notification for at least one of the offerors regarding the indication from the real-time bidding server that the cooperative offer is accepted. In some embodiments, the notification is related to a plurality of cooperative offers associated with at least one of the offerors. In some embodiments, the memory further stores instructions for: obtaining an indication from the real-time bidding server that the cooperative offer is not accepted; generating an updated cooperative offer, based on the cooperative offer provided for the real-time bidding server; and storing the updated cooperative offer.

In one embodiment, a cooperative offer generation method is disclosed, comprising: obtaining one or more keywords; identifying an item related to the one or more keywords; determining a plurality of offerors corresponding to the item; obtaining cooperative offer parameters for the offerors; generating, via a processor, a cooperative offer related to the item, including: determining a cooperative offer value, and determining a cooperative offer value share for at least one of the offerors; and providing the generated cooperative offer. In some embodiments, the cooperative offer is an online advertisement bid to advertise the item. In some embodiments, the method further comprises: obtaining an offer request; and providing the generated cooperative offer after obtaining the offer request. In some embodiments, the method further comprises: obtaining one or more other offers; combining the generated cooperative offer with the one or more other offers to generate a consolidated offer; and providing the generated consolidated offer. In some embodiments, the method further comprises: retrieving the generated cooperative offer from storage. In some embodiments, generating the cooperative offer occurs substantially in real-time after obtaining the offer request. In some embodiments, obtaining the cooperative offer parameters comprises: retrieving the cooperative offer parameters from storage. In some embodiments, obtaining the cooperative offer parameters comprises: providing a request for the cooperative offer parameters to one of: a client apparatus; and a server associated with at least one of the plurality of offerors. In some embodiments, the method further comprises: providing a uniform resource locator for an advertisement corresponding to the cooperative offer. In some embodiments, the method further comprises: deducting the cooperative offer value share from an account associated with the at least one of the offerors.

In some embodiments, providing the generated cooperative offer comprises: identifying a network address for a real-time bidding server; and providing the generated cooperative offer for the real-time bidding server using the identified network address. In some embodiments, the method further comprises: obtaining an indication from the real-time bidding server that the cooperative offer is accepted; and determining the cooperative offer value share after obtaining the indication from the real-time bidding server that the cooperative offer is accepted. In some embodiments, the method further comprises: generating a report related to the item; and storing the generated report. In some embodiments, the method further comprises: providing a notification for at least one of the offerors regarding the indication from the real-time bidding server that the cooperative offer is accepted. In some embodiments, the notification is related to a plurality of cooperative offers associated with at least one of the offerors. In some embodiments, the method further comprises: obtaining an indication from the real-time bidding server that the cooperative offer is not accepted; generating an updated cooperative offer, based on the cooperative offer provided for the real-time bidding server; and storing the updated cooperative offer.

In one embodiment, a non-transitory computer-readable medium is disclosed, storing computer-executable cooperative offer generation instructions comprising instructions for: obtaining one or more keywords; identifying an item related to the one or more keywords; determining a plurality of offerors corresponding to the item; obtaining cooperative offer parameters for the offerors; generating a cooperative offer related to the item, including: determining a cooperative offer value, and determining a cooperative offer value share for at least one of the offerors; and providing the generated cooperative offer. In some embodiments, the cooperative offer is an online advertisement bid to advertise the item. In some embodiments, the medium further stores instructions for: obtaining an offer request; and providing the generated cooperative offer after obtaining the offer request. In some embodiments, the medium further stores instructions for: retrieving the generated cooperative offer from storage. In some embodiments, the instructions are configured for generating the cooperative offer substantially in real-time after obtaining the offer request. In some embodiments, the medium further stores instructions for: obtaining one or more other offers; combining the generated cooperative offer with the one or more other offers to generate a consolidated offer; and providing the generated consolidated offer. In some embodiments, the instructions for obtaining the cooperative offer parameters comprise instructions for: retrieving the cooperative offer parameters from storage. In some embodiments, the instructions for obtaining the cooperative offer parameters comprise instructions for: providing a request for the cooperative offer parameters to one of: a client apparatus; and a server associated with at least one of the plurality of offerors. In some embodiments, the memory further stores instructions for: providing a uniform resource locator for an advertisement corresponding to the cooperative offer. In some embodiments, the memory further stores instructions for: deducting the cooperative offer value share from an account associated with the at least one of the offerors.

In some embodiments, the instructions for providing the generated cooperative offer comprise instructions for: identifying a network address for a real-time bidding server; and providing the generated cooperative offer for the real-time bidding server using the identified network address. In some embodiments, the medium further stores instructions for: obtaining an indication from the real-time bidding server that the cooperative offer is accepted; and determining the cooperative offer value share after obtaining the indication from the real-time bidding server that the cooperative offer is accepted. In some embodiments, the medium further stores instructions for: generating a report related to the item; and storing the generated report. In some embodiments, the medium further stores instructions for: providing a notification for at least one of the offerors regarding the indication from the real-time bidding server that the cooperative offer is accepted. In some embodiments, the notification is related to a plurality of cooperative offers associated with at least one of the offerors. In some embodiments, the medium further stores instructions for: obtaining an indication from the real-time bidding server that the cooperative offer is not accepted; generating an updated cooperative offer, based on the cooperative offer provided for the real-time bidding server; and storing the updated cooperative offer.

In one embodiment, a client apparatus is disclosed, comprising: a processor; a display unit disposed in communication with the processor; and a memory disposed in communication with the processor and storing processor-executable instructions, the instructions comprising instructions for: providing a request for display content; obtaining an advertisement selected for delivery to the client apparatus based on a cooperative offer submitted to a bidding server; rendering the advertisement for display; and displaying the advertisement via the display unit. In some embodiments, the memory further stores instructions for: obtaining a request for cookie information based on which the cooperative offer is submitted to the bidding server; and providing the requested cookie information. In some embodiments, providing the request for the display content occurs after the cooperative offer is generated for submission to the bidding server. In some embodiments, the advertisement includes indication of one or more items corresponding to the cooperative offer. In some embodiments, the advertisement includes indication of one or more sellers for the one or more items. In some embodiments, the advertisement includes indication of one or more offerors corresponding to the cooperative offer. In some embodiments, the advertisement is displayed via a digital medium.

In one embodiment, a cooperative offer-based advertising method is disclosed, comprising: providing a request for display content; obtaining an advertisement selected for delivery to a client apparatus based on a cooperative offer submitted to a bidding server; rendering, via a processor, the advertisement for display; and displaying the advertisement via a display unit. In some embodiments, the method further comprises: obtaining a request for cookie information based on which the cooperative offer is submitted to the bidding server; and providing the requested cookie information. In some embodiments, providing the request for the display content occurs after the cooperative offer is generated for submission to the bidding server. In some embodiments, the advertisement includes indication of one or more items corresponding to the cooperative offer. In some embodiments, the advertisement includes indication of one or more sellers for the one or more items. In some embodiments, the advertisement includes indication of one or more offerors corresponding to the cooperative offer. In some embodiments, the advertisement is displayed via a digital medium.

In one embodiment, a non-transitory computer-readable medium is disclosed, storing computer-executable cooperative offer-based advertising instructions comprising instructions for: providing a request for display content; obtaining an advertisement selected for delivery to a client apparatus based on a cooperative offer submitted to a bidding server; rendering the advertisement for display; and displaying the advertisement via a display unit. In some embodiments, the medium further stores instructions for: obtaining a request for cookie information based on which the cooperative offer is submitted to the bidding server; and providing the requested cookie information. In some embodiments, providing the request for the display content occurs after the cooperative offer is generated for submission to the bidding server. In some embodiments, the advertisement includes indication of one or more items corresponding to the cooperative offer. In some embodiments, the advertisement includes indication of one or more sellers for the one or more items. In some embodiments, the advertisement includes indication of one or more offerors corresponding to the cooperative offer. In some embodiments, the advertisement is displayed via a digital medium.

### Computer System

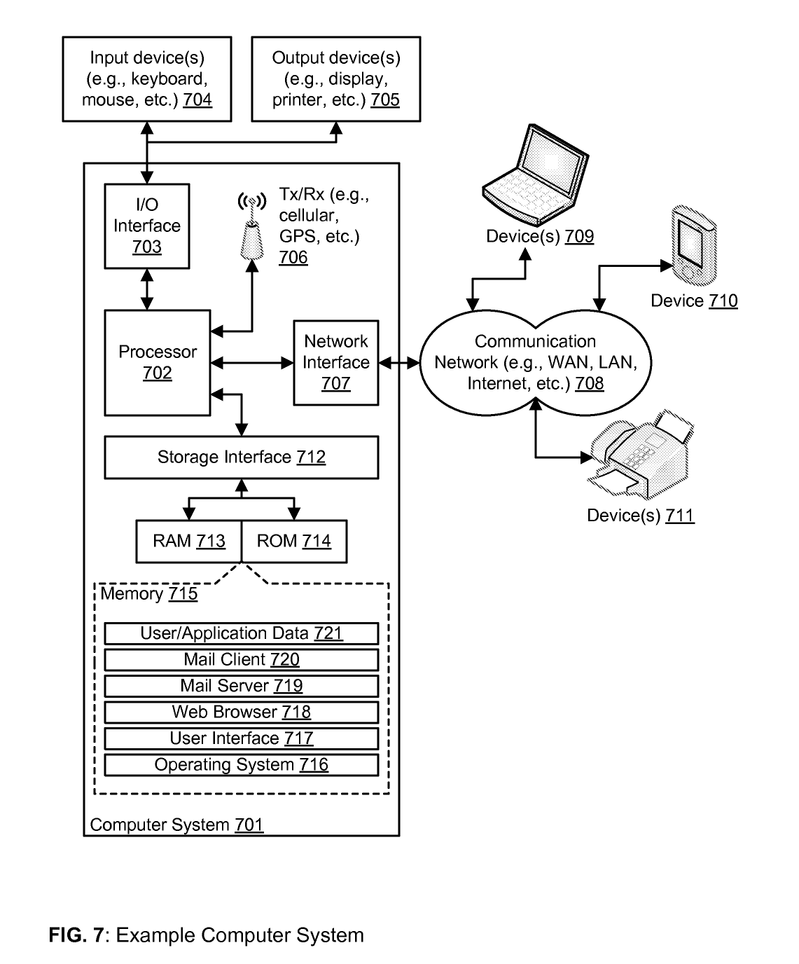

FIG. 7 is a block diagram of an example computer system for implementing embodiments consistent with the present disclosure. Variations of computer system 701 may be used for implementing, for example, client 102, RTB-DSP server(s) 406a-n, publisher server 503, publisher ad server 504, RTB-SSP server 505, and marketer ad/CDN server(s) 508a-m. Computer system 701 may comprise a central processing unit (“CPU” or “processor”) 702. Processor 702 may comprise at least one data processor for executing program components for executing user- or system-generated requests. A user may include a person, a person using a device such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 702 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 702 may be disposed in communication with one or more input/output (I/O) devices via I/O interface 703. The I/O interface 703 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 703, the computer system 701 may communicate with one or more I/O devices. For example, the input device 704 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 705 may be a printer, fax machine, video display (e.g., cathode ray tube (CRT), liquid crystal display (LCD), light-emitting diode (LED), plasma, or the like), audio speaker, etc. In some embodiments, a transceiver 706 may be disposed in connection with the processor 702. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11 a/b/g/n, Bluetooth, FM, global positioning system (GPS), 2G/3G HSDPA/HSUPA communications, etc.

In some embodiments, the processor 702 may be disposed in communication with a communication network 708 via a network interface 707. The network interface 707 may communicate with the communication network 708. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 708 may include, without limitation, a direct interconnection, local area network (LAN), wide area network (WAN), wireless network (e.g., using Wireless Application Protocol), the Internet, etc. Using the network interface 707 and the communication network 708, the computer system 701 may communicate with devices 710, 711, and 712. These devices may include, without limitation, personal computer(s), server(s), fax machines, printers, scanners, various mobile devices such as cellular telephones, smartphones (e.g., Apple iPhone, Blackberry phones, Microsoft Windows Mobile phones, Android-based phones, etc.), tablet computers (e.g., Apple iPad, Samsung Galaxy, Google Nexus, Amazon Kindle Fire, etc.), eBook readers (Amazon Kindle, Nook, etc.), laptop computers, notebooks, gaming consoles (Microsoft Xbox, Nintendo DS, Sony PlayStation, etc.), or the like. In some embodiments, the computer system 701 may itself embody one or more of these devices.

In some embodiments, the processor 702 may be disposed in communication with one or more memory devices (e.g., RAM 713, ROM 714, etc.) via a storage interface 712. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc. Variations of memory devices may be used for implementing, for example, RTB-DSP DB(s) 507a-n.

The memory devices may store a collection of program or database components, including, without limitation, an operating system 716, user interface application 717, web browser 718, mail server 719, mail client 720, user/application data 721 (e.g., any data variables or data records discussed in this disclosure), etc. The operating system 716 may facilitate resource management and operation of the computer system 701. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 717 may facilitate display, execution, interaction, manipulation, or operation of program components through textual or graphical facilities. For example, user interfaces may provide computer interaction interface elements on a display system operatively connected to the computer system 701, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 701 may implement a web browser 718 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 701 may implement a mail server 719 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 701 may implement a mail client 720 stored program component. The mail client may be a mail viewing application, such as Apple Mail, Microsoft Entourage, Microsoft Outlook, Mozilla Thunderbird, etc.

In some embodiments, computer system 701 may store user/application data 721, such as the data, variables, records, etc. (e.g., bidder name 215a, bidder type 215b, retailer SKU URL 215c, cooperative bidding flag (see 215d), bidding systems list (see 215e), marketing ad server/content delivery network list (see 215f), bidder ID 216, SKU ID 221, SKU name 222, SKU category data structure 223, active flag (see 224), cooperative bid flag (see 225a), maximum bid 226, bid override 227, market price 228, various cooperative offer parameters (see 231a-d, 232a-c, 234a-b, 235, and 236a-c), SKU data (see 243a-b), creative files (see 246), creative settings (e.g., URL, preferences—see 247a-d), cooperative bid-related data (see 250-255), etc.) as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of any computer or database component may be combined, consolidated, or distributed in any working combination.

The specification has described cooperative offering methods and systems. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

1. A cooperative offer generating system, comprising:
a processor; and
a memory storing processor-executable instructions comprising instructions for:
obtaining one or more parameters;
identifying a single item for advertisement related to the one or more parameters;
determining a plurality of offerors based on the identified single item for advertisement;
obtaining one or more cooperative offer parameters from the plurality of offerors;
dynamically determining a subset of the plurality of offerors to generate a cooperative offer to display a single advertisement for the single item;
generating the cooperative offer to display the single advertisement for the single item, including:
determining a cooperative offer value, and
determining a cooperative offer value share for at least one of the offerors; and
providing the generated cooperative offer.

2. The system of claim 1, wherein the cooperative offer is an online advertisement bid to advertise the item.

3. The system of claim 1, the memory further storing instructions for:
obtaining an offer request; and
providing the generated cooperative offer after obtaining the offer request.

4. The system of claim 1, the memory further storing instructions for:
obtaining one or more other offers;
combining the generated cooperative offer with the one or more other offers to generate a consolidated offer; and
providing the generated consolidated offer.

5. The system of claim 1, the memory further storing instructions for:
retrieving the generated cooperative offer from storage.

6. (canceled)

7. The system of claim 1, wherein the instructions for obtaining the cooperative offer parameters comprise instructions for:
retrieving the cooperative offer parameters from storage.

8-9. (canceled)

10. The system of claim 9, the memory further storing instructions for:
obtaining an indication from the real-time bidding server that the cooperative offer is accepted; and
determining the cooperative offer value share after obtaining the indication from the real-time bidding server that the cooperative offer is accepted.

11. A cooperative offer generation method, comprising:
obtaining one or more parameters;
identifying a single item for advertisement related to the one or more parameters;
determining a plurality of offerors based on the identified single item for advertisement;
obtaining one or more cooperative offer parameters from the plurality of offerors;
dynamically determining a subset of the plurality of offerors to generate a cooperative offer to display a single advertisement for the single item;
generating, via a processor, the cooperative offer to display the single advertisement for the single item, including:
determining a cooperative offer value, and
determining a cooperative offer value share for at least one of the offerors; and
providing the generated cooperative offer.

12. The method of claim 11, wherein the cooperative offer is an online advertisement bid to advertise the item.

13. The method of claim 11, further comprising:
obtaining an offer request; and
providing the generated cooperative offer after obtaining the offer request.

14. The method of claim 11, further comprising:
obtaining one or more other offers;
combining the generated cooperative offer with the one or more other offers to generate a consolidated offer; and
providing the generated consolidated offer.

15. The method of claim 11, further comprising:
retrieving the generated cooperative offer from storage.

16. (canceled)

17. The method of claim 11, wherein obtaining the cooperative offer parameters comprises:
retrieving the cooperative offer parameters from storage.

18-19. (canceled)

20. The method of claim 19, further comprising:
obtaining an indication from the real-time bidding server that the cooperative offer is accepted; and
determining the cooperative offer value share after obtaining the indication from the real-time bidding server that the cooperative offer is accepted.

21. A non-transitory computer-readable medium storing computer-executable cooperative offer generation instructions comprising instructions for:
obtaining one or more parameters;
identifying a single item for advertisement related to the one or more parameters;
determining a plurality of offerors based on the identified single item for advertisement;
obtaining one or more cooperative offer parameters from the plurality of offerors;
dynamically determining a subset of the plurality of offerors to generate a cooperative offer to display a single advertisement for the single item;
generating the cooperative offer to display the single advertisement for the single item, including:
determining a cooperative offer value, and
determining a cooperative offer value share for at least one of the offerors; and
providing the generated cooperative offer.

22. The medium of claim 21, wherein the cooperative offer is an online advertisement bid to advertise the item.

23. The medium of claim 21, further storing instructions for:
obtaining an offer request; and
providing the generated cooperative offer after obtaining the offer request.

24. The medium of claim 21, further storing instructions for:
obtaining one or more other offers;
combining the generated cooperative offer with the one or more other offers to generate a consolidated offer; and
providing the generated consolidated offer.

25. The medium of claim 21, further storing instructions for:
retrieving the generated cooperative offer from storage.

26. (canceled)

27. The medium of claim 21, wherein the instructions for obtaining the cooperative offer parameters comprise instructions for:
retrieving the cooperative offer parameters from storage.

28-29. (canceled)

30. The medium of claim 29, further storing instructions for:
obtaining an indication from the real-time bidding server that the cooperative offer is accepted; and
determining the cooperative offer value share after obtaining the indication from the real-time bidding server that the cooperative offer is accepted.

31. The system of claim 1, wherein the single advertisement is obtained from a single server source.

32. The system of claim 1, wherein dynamically determining the subset of the plurality of offerors is based on a return-on-investment target.

33. The system of claim 1, wherein determining the cooperative offer value share is based on a return-on-investment target.

34. The method of claim 11, wherein the single advertisement is obtained from a single server source.

35. The method of claim 11, wherein dynamically determining the subset of the plurality of offerors is based on a return-on-investment target.

36. The method of claim 11, wherein determining the cooperative offer value share is based on a return-on-investment target.

37. The medium of claim 21, wherein the single advertisement is obtained from a single server source.

38. The medium of claim 21, wherein dynamically determining the subset of the plurality of offerors is based on a return-on-investment target.

39. The medium of claim 21, wherein determining the cooperative offer value share is based on a return-on-investment target.
